(19) United States
(12) Patent Application Publication
(10) Pub. No.: US 2025/0110738 A1
(43) Pub. Date: Apr. 3, 2025

(54) PROCESSOR AND METHOD FOR CONTROLLING PROCESSOR

(71) Applicant: Preferred Networks, Inc., Tokyo (JP)

(72) Inventors: Ryosuke KURAMOCHI, Tokyo (JP); Kenji TAGATA, Tokyo (JP); Harunobu MIYASHITA, Tokyo (JP)

(21) Appl. No.: 18/897,595

(22) Filed: Sep. 26, 2024

(30) Foreign Application Priority Data
Sep. 29, 2023 (JP) 2023-169038

(51) Int. Cl. G06F 9/30; G06F 9/35; G06F 9/38

(52) U.S. Cl. CPC G06F 9/30087; G06F 9/35; G06F 9/3814

(57) ABSTRACT

A processor includes a first arithmetic device configured to execute a first instruction, and a second arithmetic device configured to execute a second instruction and a third instruction. The first arithmetic device calculates first data by executing the first instruction. The second arithmetic device stops execution of the third instruction based on the second instruction which is an instruction for waiting issuance of first synchronization information, and thereafter executes the third instruction that uses the first data, based on the issuance of the first synchronization information from the first arithmetic device.

### CROSS-REFERENCE TO RELATED APPLICATIONS

This application is based upon and claims priority to Japanese Patent Application No. 2023-169038, filed on Sep. 29, 2023, the entire contents of which are incorporated herein by reference.

### BACKGROUND

### 1. Technical Field

The present disclosure is related to processors, and methods for controlling processors.

### 2. Description of the Related Art

For example, in a processor including different types of arithmetic devices having different functions, the different types of arithmetic devices may be synchronized to cause one of the arithmetic devices to execute a process that cannot be executed by another arithmetic device. In this case, an improvement in a processing performance of the processor can be expected.

### SUMMARY

In the present disclosure, the processing performance of the processor is improved by operating the different types of arithmetic devices included in the processor in synchronism with one another.

A processor according to one embodiment of the present disclosure includes a first arithmetic device configured to execute a first instruction; and a second arithmetic device configured to execute a second instruction and a third instruction, wherein the first arithmetic device calculates first data by executing the first instruction, and the second arithmetic device stops execution of the third instruction based on the second instruction which is an instruction for waiting issuance of first synchronization information, and thereafter executes the third instruction that uses the first data, based on the issuance of the first synchronization information from the first arithmetic device.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a block diagram illustrating an example of a configuration of a processor according to one embodiment of the present disclosure;

FIG. 2 is a timing diagram illustrating an example of a synchronization method between a PE and a CPU in the processor illustrated in FIG. 1;

FIG. 3 is a diagram illustrating an example of a movement of data between the PE and a CPU unit by a tag synchronization in the processor illustrated in FIG. 1;

FIG. 4 is a block diagram illustrating an example of the configuration of the processor according to another embodiment of the present disclosure;

FIG. 5 is a diagram illustrating an example of an operation of the processor in a case where the PE illustrated in FIG. 4 is caused to selectively execute a plurality of processes;

FIG. 6 is a block diagram illustrating an example of the configuration of the processor according to another embodiment of the present disclosure;

FIG. 7 is a diagram illustrating an example of the operation of the processor in a case where the PE illustrated in FIG. 6 is caused to selectively execute a plurality of processes;

FIG. 8 is a diagram illustrating another example of an instruction supply circuit illustrated in FIG. 4 or FIG. 6;

FIG. 9 is a diagram illustrating an example of the operation of the processor in a case where the instruction supply circuit illustrated in FIG. 4 includes an instruction buffer IBUFb illustrated in FIG. 8;

FIG. 10 is a block diagram illustrating an example of the configuration of the processor according to another embodiment of the present disclosure;

FIG. 11 is a diagram illustrating an example of the operation of the processor in a case where the PE illustrated in FIG. 10 is caused to selectively execute a plurality of processes;

FIG. 12 is a diagram illustrating another example of the operation of the processor in the case where the PE illustrated in FIG. 10 is caused to selectively execute the plurality of processes; and

FIG. 13 is a block diagram illustrating an example of a hardware configuration of a computer installed with the processor illustrated in FIG. 1.

### DETAILED DESCRIPTION

Hereinafter, embodiments of the present disclosure will be described in detail with reference to the drawings. Although not particularly limited, a processor described below may be installed in a computer, such as a server or the like, and execute a program (instruction) to perform a convolution operation or the like in training or inference of a deep neural network, for example. The processor described below may be used for scientific computing.

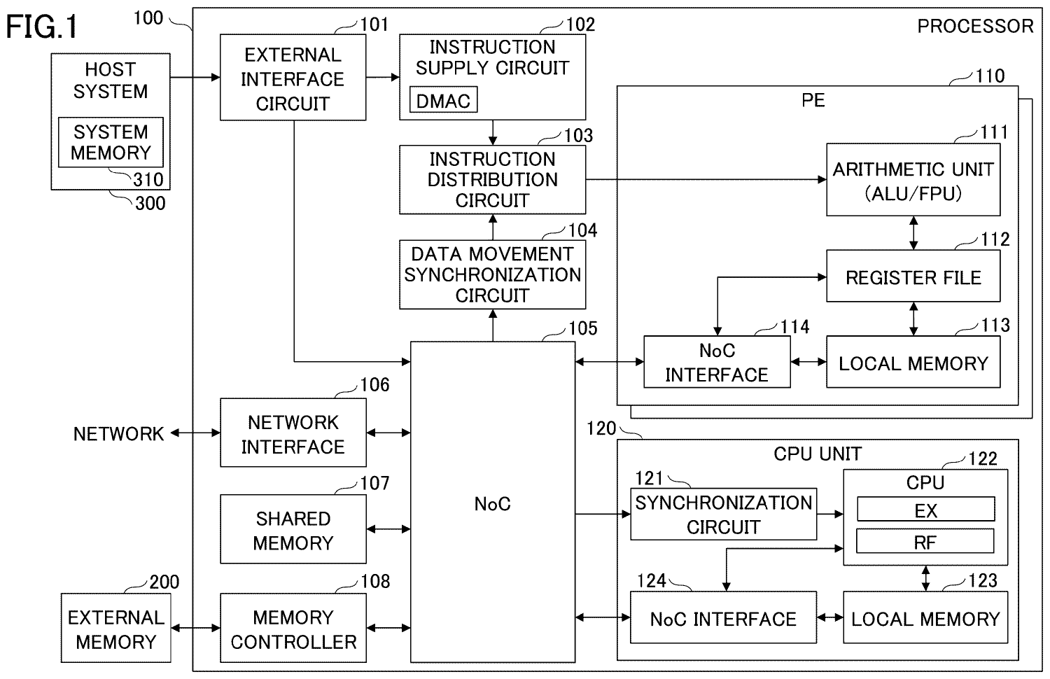

FIG. 1 is a block diagram illustrating an example of a configuration of a processor according to one embodiment of the present disclosure. A processor 100 illustrated in FIG. 1 may be installed on a board of a server or the like that is not illustrated, together with an external memory 200. A plurality of processors 100 may be installed on a single board. In this case, the external memory 200 may be provided for each processor 100 of the plurality of processors 100, or may be provided in common with respect to the plurality of processors 100. The external memory 200 is an example of a storage device. The processor 100 may be connected to a host system 300 via the board. Arrows illustrated in FIG. 1 mainly indicate data transfer pathways, and the illustration of control signal transfer pathways may be omitted.

The processor 100 may be a single instruction multiple data (SIMD) processor or a single instruction multiple threads (SIMT) processor, for example. The processor 100 may include an external interface circuit 101, an instruction supply circuit 102, an instruction distribution circuit 103, a data movement synchronization circuit 104, a network on chip (NoC) 105, a network interface 106, a shared memory 107, a memory controller 108, a plurality of processor elements (PEs) 110, and a central processing unit (CPU) unit 120. In addition, the processor 100 may include a single PE 110. The PE 110, the instruction supply circuit 102, and the instruction distribution circuit 103 are examples of a first arithmetic device. The instruction supply circuit 102 and the instruction distribution circuit 103 are examples of an instruction supply control circuit. The CPU unit is an example of a second arithmetic device. The CPU unit may sometimes also be referred to as a CPU block. In addition, the processor 100 may be configured as a single chip, or may be configured by a plurality of chips.

Each PE 110 may include an arithmetic unit 111, a register file 112, a local memory 113, and a NoC interface 114. The arithmetic unit 111 may include an arithmetic logic unit (ALU) and a floating point unit (FPU). The ALU and the FPU are examples of a first arithmetic unit.

The CPU unit 120 may include a synchronization circuit 121, a CPU 122, a local memory 123, and a NoC interface 124. The CPU 122 may include a plurality of types of arithmetic elements EX, and a register file RF. For example, the CPU unit 120 can execute a process that is difficult to execute in the PE 110. The PE 110 and the CPU unit 120 have functions to mutually synchronize execution of instructions.

The PE 110 and the CPU unit 120 have different processing performances and functions. For example, the PE 110 can process arithmetic operations performed on a large number of data at a high speed, by executing an arithmetic instruction supplied from the host system 300 in parallel using a large number of arithmetic units. The CPU unit 120 fetches and executes instructions held in the local memory 123, and can execute not only an arithmetic instruction but also a branch instruction, such as a conditional branch instruction or the like.

The CPU unit 120 may include a graphics processing unit (GPU), a general purpose computing on GPU (GPGPU), a digital signal processor (DSP), an image signal processor (ISP), custom hardware, or a PE of a type different from the PE 110, in place of the CPU 122.

The external interface circuit 101 may be connected to the host system 300 via a peripheral component interconnect express (PCIe) bus or the like, for example. The external interface circuit 101 may control communication between the processor 100 and the host system 300.

A data move instruction and an arithmetic instruction to be executed in the CPU 122, among a sequence of instructions read from the system memory 310 of the host system 300, may be transferred to the local memory 123 of the CPU unit 120 via the external interface circuit 101, the NoC 105, and the NoC interface 124. Among the instructions read from the system memory 310 of the host system 300, instructions other than the instructions to be executed in the CPU 122, may be transferred to the instruction supply circuit 102 via the external interface circuit 101. For example, the instruction transferred to the instruction supply circuit 102 may include an arithmetic instruction to be executed in the PE 110, and a wait instruction and a data move instruction issued from the host system 300. The system memory 310 is an example of a storage device.

Hereinafter, the arithmetic instruction, the data move instruction, and the wait instruction to be executed in the CPU 122 may also be referred to as CPU instructions. The arithmetic instruction to be executed in the PE 110, and the wait instruction and the data move instruction issued from the host system 300 may also be referred to as host instructions.

The arithmetic instruction to be executed in the PE 110 may be supplied to the arithmetic unit 111 via the instruction supply circuit 102 and the instruction distribution circuit 103, and executed by an arithmetic element within the arithmetic unit 111. The arithmetic instruction supplied to the PE 110 may be executed by the arithmetic element within the arithmetic unit 111 without imposing conditions. The instruction to be executed in the CPU 122 may be stored in the local memory 123 via the NoC 105 and the NoC interface 124, and thereafter executed by the CPU 122 by fetching the instruction held in the local memory 123.

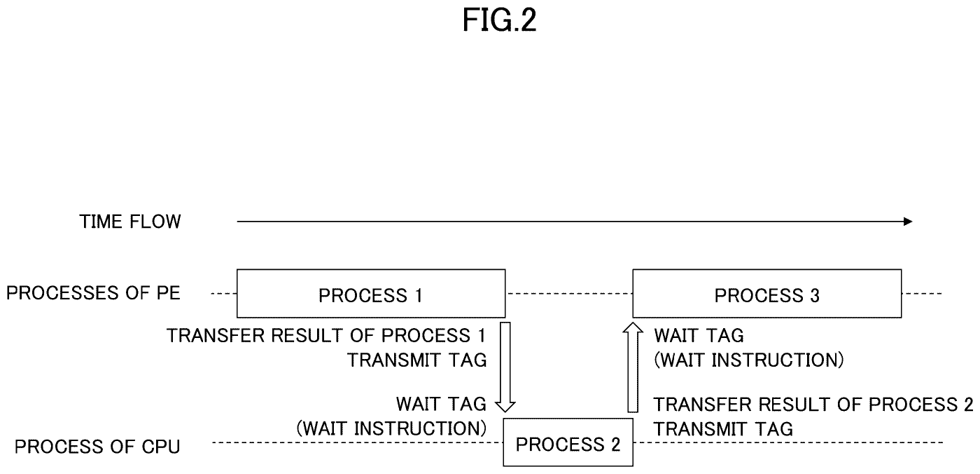

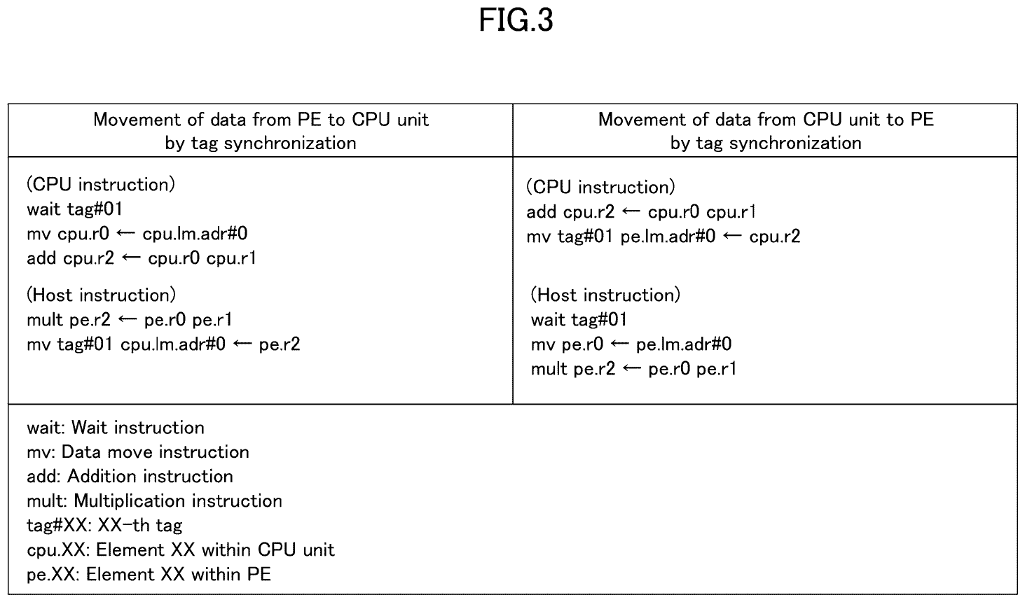

For example, the instruction read from the system memory 310 may include a multiplication instruction, an addition instruction, a data move instruction, a wait instruction, a stop instruction, or the like, which will be described later. The multiplication instruction and the addition instruction may include a fixed-point instruction and a floating-point instruction, respectively. The data move instruction may include an instruction including a tag for synchronization of the instruction, and an instruction including no tag. The wait instruction may include a tag for synchronization of the instruction. A synchronization control of the instruction using the tag will be described with reference to FIG. 2 and FIG. 3.

The instruction supply circuit 102 may supply the arithmetic instruction for the PE 110, supplied from the external interface circuit 101, to the instruction distribution circuit 103. The instruction supply circuit 102 may include a direct memory access controller (DMAC). The DMAC functions as a data moving circuit. The DMAC may operate based on the data move instruction issued from the host system 300, and move data from a transfer source to a transfer destination. In this case, the data move instruction issued from the host system 300 is different from the data move instruction transferred to the local memory 123 and executed in the CPU 122. The DMAC may be booted by CPU 122. The DMAC may be disposed between the external interface circuit 101 and the NoC 105, or may be disposed within the NoC 105.

The instruction distribution circuit 103 may output the arithmetic instruction for the PE 110, received from the instruction supply circuit 102, to each of the arithmetic units 111 of the plurality of PEs 110 in parallel. The arithmetic elements (ALUs or the like) within each of the arithmetic units 111 of the plurality of PEs 110 may execute the received arithmetic instructions in parallel. In addition, the arithmetic element within the arithmetic unit 111 in each PE 110 may unconditionally execute the arithmetic instruction in a case where the arithmetic instruction is received. However, in a case where the wait instruction is received, the instruction distribution circuit 103 may inhibit the output of the arithmetic instruction subsequent to (or following) the wait instruction to the PE 110, until a tag which is the same as the tag included in the wait instruction is received from the data movement synchronization circuit 104. The data movement synchronization circuit 104 may output the tag received from the NoC 105 to the instruction distribution circuit 103.

The NoC 105 can transfer data between one of the shared memory 107, the external memory 200, and the network, and one of the local memory 113 and the local memory 123. The NoC 105 can transfer data between the register file 112 of the PE 110 and the local memory 123 of the CPU unit 120, or between the local memory 113 of the PE 110 and the register file RF of the CPU 122.

When the data is moved from the CPU unit 120 to the PE 110 in response to the data move instruction including the tag executed by the CPU unit 120, the NoC 105 may output the tag to the data movement synchronization circuit 104. In addition, when the data is moved from the PE 110 to the CPU unit 120 in response to the data move instruction including the tag issued from the host system 300, the NoC 105 may output the tag to the synchronization circuit 121 of the CPU unit 120.

Moreover, when the CPU unit 120 executes the data move instruction to input data to or output data from the system memory 310, the NoC 105 may transfer an access request and write data to the system memory 310 or may transfer data read from the system memory 310 to the CPU unit 120. When the DMAC inputs data to or outputs data from the system memory 310 based on the data move instruction, the NoC 105 may transfer the access request and the write data to the system memory 310 or may transfer the data read from the system memory 310 to a write destination.

The PE 110 may execute an arithmetic instruction issued from the host system 300 and transferred via the instruction distribution circuit 103. For this reason, the PE 110 does not require a function to fetch an arithmetic instruction, and does not require a program counter.

In the PE 110, each of the arithmetic element within the arithmetic unit 111 may read out data to be subjected to an arithmetic operation from the register file 112, based on the arithmetic instruction supplied from the instruction distribution circuit 103. Each arithmetic element may perform the arithmetic operation using the read data, and store data of an arithmetic result in the register file 112. The register file 112 may include a plurality of registers used in the arithmetic unit 111. Each register of the plurality of registers may be assigned a register number or address, such that each register may be identified by the register number or address.

The local memory 113 may be a static random access memory (SRAM), for example. The local memory 113 may hold the data used by the arithmetic unit 111, the arithmetic result of the arithmetic unit 111, or the like via the register file 112. Because the PE 110 does not have the function of fetching the instruction, local memory 123 is not required to store the instruction. The NoC interface 114 may control the movement of data between the register file 112 or the local memory 113 and the NoC 105.

In the CPU unit 120, the CPU 122 may fetch the instruction held in the local memory 123, and execute the fetched instruction. In a case where the fetched instruction is an arithmetic instruction, the CPU 122 may perform an arithmetic operation using the data read from the internal register file RF, and store the data of the arithmetic result in the internal register file RF. When the fetched instruction is the data move instruction, the CPU 122 may move the data by executing the data move instruction. However, in a case where the CPU 122 fetches a wait instruction including a tag, the CPU 122 may prohibit execution of the fetched instruction until a tag is received from the synchronization circuit 121.

The synchronization circuit 121 may inhibit the CPU 122 from executing an instruction subsequent to the wait instruction, until the tag included in the wait instruction fetched by the CPU 122 from the local memory 123 is received the NoC 105. In a case where the synchronization circuit 121 receives the tag included in the wait instruction from the NoC 105, the synchronization circuit 121 may permit the CPU 122 to execute the instruction subsequent to the wait instruction.

The local memory 123 may hold instructions (programs) executed by the CPU 122 and data used in the instructions. The NoC interface 124 may control the movement of data between the register file RF within the CPU 122 or the local memory 123 and the NoC 105.

The network interface 106 may connect the processor 100 to a network. In a case where an address of a movement source or an address of a movement destination included in the data move instruction indicates a storage area of a memory that is not illustrated and is arranged in the network, the NoC 105 may output a memory access request to the network via the network interface 106.

The shared memory 107 may be an SRAM, for example. The shared memory 107 may hold data used by the arithmetic unit 111 or the arithmetic element EX, an arithmetic result of the arithmetic unit 111 or the arithmetic element EX, or the like. In the case where the NoC 105 makes access to the shared memory 107, the NoC 105 may output a memory access request to the shared memory 107.

The memory controller 108 may control access to the external memory 200. Although not particularly limited, the external memory 200 may be a main storage device, such as a dynamic random access memory (DRAM) or the like, for example. The external memory 200 may be a nonvolatile memory to which data is electrically rewritable, such as a flash memory or the like, or may be a nonvolatile storage device that stores data magnetically or using resistance values. For example, the memory controller 108 may include a queue that holds a plurality of memory access requests received from the NoC 105, and successively issue the memory access requests held in the queue to the external memory 200.

FIG. 2 is a timing diagram illustrating an example of a synchronization method between the PE 110 and the CPU 122 in the processor 100 illustrated in FIG. 1. FIG. 2 illustrates an example of a control method of the processor 100. FIG. 2 illustrates an example in which the CPU 122 executes a process 2 using a result of a process 1 executed by the PE 110, and the PE 110 executes a process 3 using the result of process 2. For this reason, the process 2 needs to be synchronized with the process 1, and the process 3 needs to be synchronized with the process 2.

In a case where the CPU 122 is caused to wait the starting of the process 2 until the completion of process 1, a wait instruction including a tag may be used. The synchronization circuit 121 of the CPU unit 120 may inhibit the CPU 122 from starting the process 2 until the tag included in the wait instruction is received from the NoC 105. After the PE 110 completes the process 1, the NoC 105 may transfer the result of the process 1 to the CPU unit 120 based on the data move instruction including the tag from the host system 300, and transmit the tag included in the data move instruction to the synchronization circuit 121.

In a case where the received tag is the same as the tag included in the wait instruction, the synchronization circuit 121 may permit the CPU 122 to execute the process 2, and the CPU 122 may start the execution of the process 2 based on the permission. Thus, the CPU 122 can start the process 2 in synchronism with the completion of the process 1 by the arithmetic unit 111.

The instruction distribution circuit 103 may receive a wait instruction including a tag for synchronizing the process 2 and the process 3, and an arithmetic instruction for the process 3 subsequent to the wait instruction, for example, from the host system 300 via the instruction supply circuit 102. The instruction distribution circuit 103 may inhibit the supply of the arithmetic instruction for the process 3 to the arithmetic unit 111, until the tag included in the wait instruction is received from the data movement synchronization circuit 104.

The CPU 122 may execute the data move instruction including the tag, for example, after the completion of the process 2. The NoC 105 may transfer the result of the process 2 to the PE 110 based on the data move instruction, and may transmit the tag included in the data move instruction to the data movement synchronization circuit 104.

The data movement synchronization circuit 104 may output the received tag to the instruction distribution circuit 103. In a case where the tag received from the data movement synchronization circuit 104 is the same as the tag included in the wait instruction, the instruction distribution circuit 103 may output the arithmetic instruction subsequent to the wait instruction to the arithmetic unit 111. Thus, the arithmetic unit 111 can start the process 3 in synchronism with the completion of the process 2 by the CPU 122.

FIG. 3 is a diagram illustrating an example of a movement of data between the PE 110 and a CPU unit 120 by a tag synchronization in the processor 100 illustrated in FIG. 1. FIG. 3 illustrates an example of a control method of the processor 100. FIG. 3 illustrates an example of the movement of the data from the PE 110 to the CPU unit 120 by a tag synchronization corresponding to a synchronization process between the process 1 and the process 2 in FIG. 2, and an example of the movement of the data from the CPU unit 120 to the PE 110 by a tag synchronization corresponding to a synchronization process between the process 2 and the process 3 in FIG. 2.

The instructions illustrated in FIG. 3 may be generated in advance by a compiler or the like, and thereafter stored in the system memory 310 of the host system 300. The instructions stored in the system memory 310 may be supplied to the instruction distribution circuit 103 via the external interface circuit 101 and the instruction supply circuit 102, or may be stored in the local memory 123 of the CPU unit 120 via the external interface circuit 101, the NoC 105, and NoC interface 124.

The tag is indicated by a tag#n (n is an identification number) in the description of the instruction. An arrow illustrated in the instruction indicates a data moving direction in the case of a data move instruction “mv”, and indicates a moving direction of an arithmetic result in the case of the arithmetic instruction. In the instruction, a symbol “cpu” indicates the CPU unit 120, and a symbol “pe” indicates the PE 110. A symbol “lm” indicates a local memory, and a symbol “r” indicates a register. The symbol “adr” indicates an address.

A “CPU instruction” indicates an instruction that is transferred from the system memory 310 to the local memory 123 of the CPU unit 120 before the synchronization process, and is fetched and processed by the CPU 122. A “host instruction” indicates an instruction that is issued from the host system 300, and includes an arithmetic instruction to be processed by the PE 110, a data move instruction to be processed by the DMAC, and a wait instruction to be used for controlling the instruction distribution circuit 103.

In the movement of the data from the PE 110 to the CPU unit 120 by a tag synchronization, the arithmetic unit 111 of the PE 110 may first calculate a product of values of registers r0 and r1 of the register file 112 based on a multiplication instruction “mult” from the instruction distribution circuit 103, and store the arithmetic result in the register r2 of the register file 112.

Next, the instruction supply circuit 102 may transfer data stored in the register r2 of the register file 112 to an area indicated by an address adr#0 of the local memory 123 of the CPU unit 120, based on the data transfer in response to the data move instruction “mv” (tag#01) including the tag#01 received from the host system 300 via the external interface circuit 101. The data transfer may be executed by the DMAC. The instruction supply circuit 102 may output the tag#01 to the synchronization circuit 121 of the CPU unit 120 via the NoC 105, based on the data transmission in response to the data move instruction “mv” (tag#01). The tag#01 included in the data move instruction “mv” (tag#01) used to move the data from the PE 110 to the CPU unit 120 is an example of first synchronization information.

The CPU unit 120 may successively fetch the wait instruction “wait” (tag#01) including the tag#01, the data move instruction “mv”, and an addition instruction “add”. The CPU unit 120 may inhibit the execution of the subsequent data move instruction “mv” and the addition instruction “add” in the subsequent stage until the tag#01 is received, based on the wait instruction “wait” (tag#01).

The synchronization circuit 121 of the CPU unit 120 may permit the CPU 122 to execute the data move instruction “mv” subsequent to the wait instruction “wait” (tag#01), based on the reception of the tag#01. The tag#01 enables the CPU unit 120 to wait for a branch condition, which is the multiplication result of the PE 110, to be stored in the local memory 123.

Then, the CPU 122 may execute the data move instruction “mv” for storing the data (multiplication result) transferred from the PE 110 and held at an address adr#0 of the local memory 123 in the register r0 of the register file RF. In addition, the CPU 122 may calculate a sum of the registers r0 and r1 of the register file RF in response to the addition instruction “add”, and store the sum in the register r2.

Accordingly, after the arithmetic result of the PE 110 is stored in the local memory 123 of the CPU unit 120, the CPU 122 can execute the addition instruction “add” by using the arithmetic result of the PE 110. That is, the completion of the process in the PE 110 and the start of the process in the CPU unit 120 can be synchronized, and it is possible to improve the processing performance of the processor. Further, a process having a data dependency in the PE 110 and the CPU unit 120 can be performed without an erroneous operation, by using the tag.

In the movement of the data from the CPU unit 120 to the PE 110 by the tag synchronization, the CPU unit 120 may successively fetch the addition instruction “add” and the data move instruction “mv” (tag#01) including the tag#01. The CPU 122 may calculate a sum of the values in the registers r0 and r1 of the register file RF, based on the fetched addition instruction “add”, and store the arithmetic result in the register r2 of the register file RF.

Moreover, the CPU 122 may store the data (addition result) stored in the register r2 of the register file RF in the area indicated by the address adr#0 of the local memory 113 of the PE 110, based on the fetched data move instruction “mv” (tag#01), and output the tag#01 to the NoC 105. The tag#01 included in the data move instruction “mv” (tag#01) used for the movement of the data from the CPU unit 120 to the PE 110 is an example of second synchronization information.

The instruction supply circuit 102 may receive a wait instruction “wait” (tag#01) including the tag#01 and a data move instruction “mv” from the host system 300 via the external interface circuit 101. In a case where the wait instruction “wait” (tag#01) is received, the instruction supply circuit 102 may inhibit the execution of the data move instruction “mv” subsequent to the wait instruction “wait” (tag#01) until the data movement synchronization circuit 104 receives the tag#01 from the CPU unit 120 via the NoC 105.

In the case where the data movement synchronization circuit 104 receives the tag#01, the instruction supply circuit 102 may cause the DMAC to execute the movement of the data based on the data move instruction “mv”. For example, the DMAC may store the data (addition result of the CPU 122) held in the storage area at the address adr#0 of the local memory 113 of the PE 110, in the register r0 of the register file 112.

The instruction supply circuit 102 may supply the multiplication instruction “mult” received from the host system 300 via the external interface circuit 101 to the instruction distribution circuit 103. The instruction distribution circuit 103 may supply the multiplication instruction “mult” from the instruction supply circuit 102 to the arithmetic unit 111. Further, the arithmetic unit 111 may calculate a product of the values in the registers r0 and r1 of the register file 112 based on the multiplication instruction “mult”, and store the arithmetic result in the register r2 of the register file 112.

Accordingly, after the arithmetic result of the CPU unit 120 is stored in the local memory 113 of the PE 110, the PE 110 can execute the multiplication instruction “mult” by using the arithmetic result of the CPU 122. That is, the completion of the process in the CPU unit 120 and the start of the process in the PE 110 can be synchronized, and it is possible to improve the processing performance of the processor. In addition, the process having the data dependency in the PE 110 and the CPU unit 120 can be performed without an erroneous operation, by using the tag.

As described above, in the embodiment illustrated in FIG. 1 through FIG. 3, the different types of PE 110 and CPU unit 120 installed on the processor 100 are synchronized with each other using the tag, and thus, a plurality of processes can be executed in coordination with each other. For this reason, the PE 110 and the CPU unit 120, which have different processing performances and functions, can be caused to execute the process the PE 110 excels at and execute the process the CPU unit 120 excels at, respectively, and it is possible to improve the processing performance of the processor 100 compared to a case where the processes are executed independently.

In addition, instead of waiting for the tag to be received by the wait instruction, a polling instruction may be input to both the PE 110 and the CPU unit 120 in place of the wait instruction. In response to the polling instruction, the CPU unit 120 may periodically confirm whether or not a required arithmetic operation is completed with respect to the PE 110, for example, or the PE 110 may periodically confirm whether or not the required arithmetic operation is completed with respect to the CPU unit 120, for example. A subsequent instruction may be processed when the CPU unit 120 or the PE 110 confirms that the required arithmetic operation is completed.

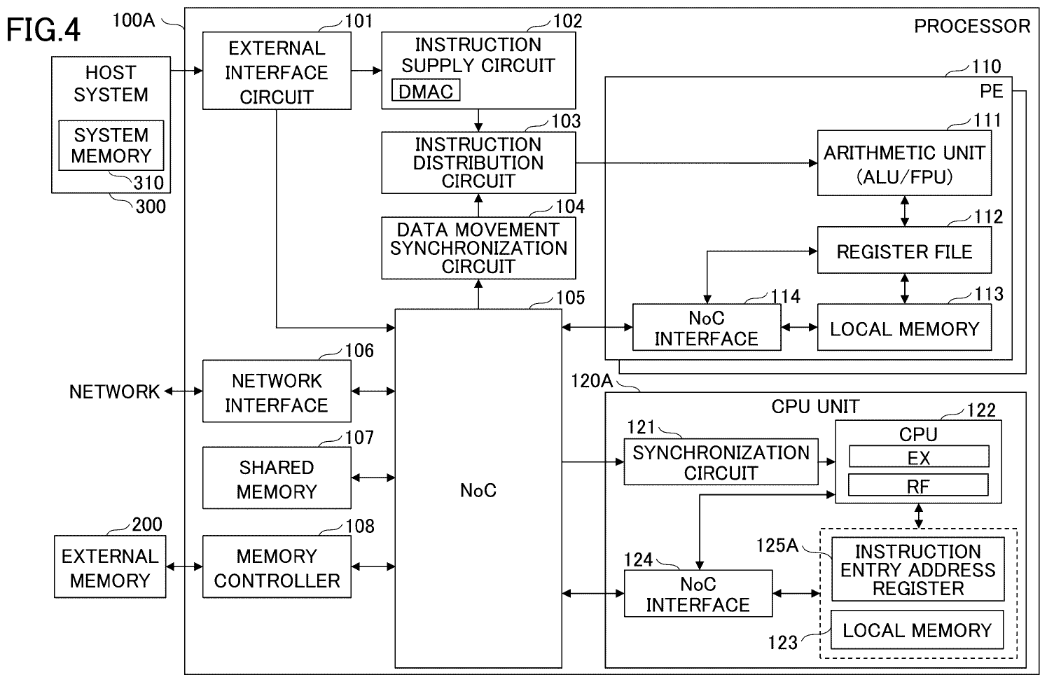

FIG. 4 is a block diagram illustrating an example of the configuration of the processor in another embodiment of the present disclosure. In FIG. 4, those circuits that are identical or similar to those corresponding circuits illustrated in FIG. 1 are designated by the same reference numerals, and a detailed description thereof will be omitted. A processor 100A illustrated in FIG. 4 has the same configuration and functions as the processor 100 illustrated in FIG. 1, except that a CPU unit 120A is provided in place of the CPU unit 120 illustrated in FIG. 1. The CPU unit 120A has the same configuration and functions as the CPU unit 120 illustrated in FIG. 1, except that the CPU unit 120A has an instruction entry address register 125A. The instruction entry address register 125A may be allocated to a part of the local memory 123. In addition, the instruction entry address register 125A may have a queue structure (first-in-first-out (FIFO) structure) including a plurality of entries. The instruction entry address register 125A is an example of an address register configured to hold a read address indicating a read source of an instruction from the storage device.

For example, the instruction entry address register 125A may hold a head address of a storage area in the system memory 310 that holds an instruction sequence to be executed by the PE 110. For example, the CPU unit 120A may store one head address among a plurality of head addresses in the instruction entry address register 125A, based on the arithmetic result of the arithmetic unit 111 of the PE 110. Further, the CPU unit 120A may transfer an arithmetic instruction of a predetermined size from the storage area of the system memory 310 having the address stored in the instruction entry address register 125A as the head address, to the PE 110. In this case, the CPU unit 120A may wait for the reception of the arithmetic result of the PE 110, by using the wait instruction “wait”.

Alternatively, the CPU unit 120A may store one head address among the plurality of head addresses in the instruction entry address register 125A, based on the arithmetic operation of the CPU 122. Further, the CPU unit 120A may transfer the arithmetic instruction of a predetermined size from the storage area of the system memory 310 having the address stored in the instruction entry address register 125A as the head address, to the PE 110. In this case, the wait instruction “wait” is not used, because the transmission and reception of the arithmetic result between the PE 110 and the CPU unit 120A is not required. However, even in this case, while the arithmetic operation of the CPU 122 and the transfer of the arithmetic instruction by the CPU unit 120A are performed, the PE 110 may be caused to perform the arithmetic operation using another instruction sequence, and the transfer of the arithmetic instruction may be waited by using the wait instruction “wait”.

As described above, the arithmetic instruction to be executed next by the PE 110 can be selectively determined, based on the arithmetic result of the PE 110 or the arithmetic result of the CPU unit 120A, and the selected arithmetic instruction can be executed by the PE 110.

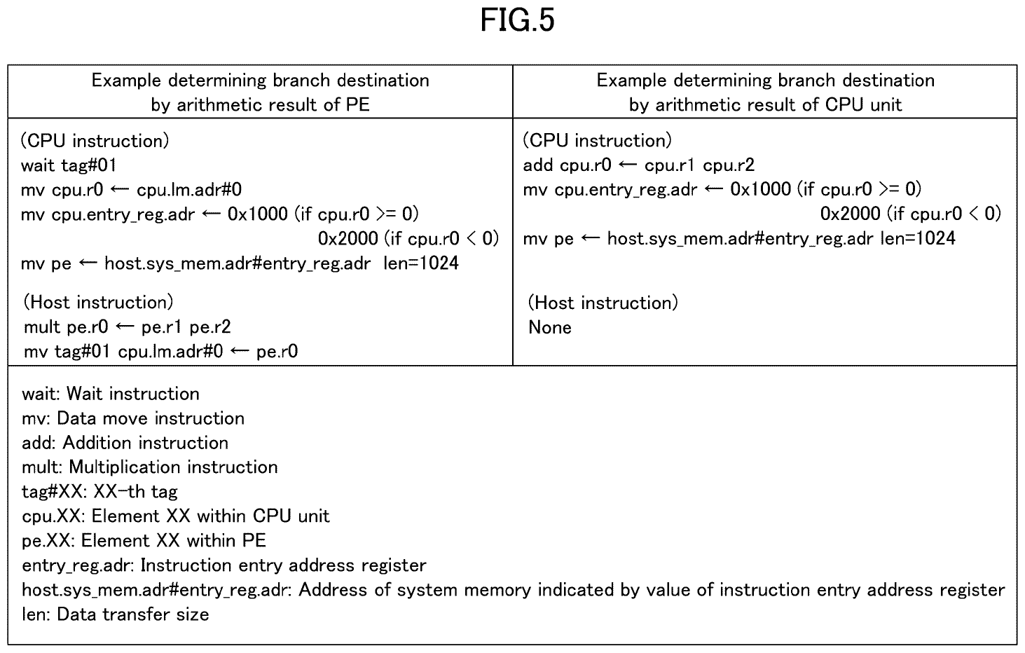

FIG. 5 is a diagram illustrating an example of the operation of the processor 100A in a case where the PE 110 illustrated in FIG. 4 is caused to selectively execute a plurality of processes. FIG. 5 illustrates an example of a method for controlling the processor 100A. A detailed description of the instructions that are identical or similar to those corresponding instructions illustrated in FIG. 3 will be omitted.

As illustrated on the left side of FIG. 5, in a case where a branch destination of the instruction to be executed by the PE 110 is determined by the arithmetic result of the PE 110, the PE 110 may first execute a multiplication instruction “mult” for multiplying the values of the registers r1 and r2 of the register file 112 by the arithmetic unit 111 and storing the multiplication result in the register r0 of the register file 112. This multiplication instruction “mult” corresponds to an instruction for determining a branch condition to be executed before a conditional branch instruction in a normal CPU or the like.

Next, the instruction supply circuit 102 may transfer the data (branch condition) stored in the register r0 of the register file 112 to the area indicated by the address adr#0 of the local memory 123 of the CPU unit 120A, based on the data move instruction “mv” (tag#01) received from the host system 300 via the external interface circuit 101. The data transfer may be executed by the DMAC. The instruction supply circuit 102 may output the tag#01 to the synchronization circuit 121 of the CPU unit 120A via the NoC 105, based on the data transfer in response to the data move instruction “mv” (tag#01). The tag#01 included in the data move instruction “mv” (tag#01) used for the movement of the data from the PE 110 to the CPU unit 120A is an example of third synchronization information.

The CPU unit 120A may execute the wait instruction “wait” (tag#01) including the tag#01, and may inhibit the execution of the instruction of the subsequent stage until the tag#01 is received. The synchronization circuit 121 of the CPU unit 120A may permit the CPU 122 to execute the data move instruction “mv” subsequent to the wait instruction “wait” (tag#01), based on the reception of the tag#01. The tag#01 enables the CPU unit 120A unit to wait for the branch condition, which is the multiplication result of the PE 110, to be stored in the local memory 123.

For example, the CPU unit 120A may execute a data move instruction “mv” for moving the branch condition stored in the local memory 123 to the register r0 of the register file RF. Next, the CPU unit 120A may execute a data move instruction “mv” for storing the address selected according to the value of the register r0 in the instruction entry address register 125A, and a data move instruction “mv” for transferring data of a predetermined size from the storage area of the system memory 310 indicated by the address stored in the instruction entry address register 125A to the PE 110. For example, the CPU unit 120A may issue a data transfer request to the DMAC, and cause the DMAC to execute a data transfer from the system memory 310 to the PE 110.

In the example illustrated in FIG. 5, when the value of the register r0 is “0” or greater, 1024 bytes of data (for example, 1024 instructions) are transferred from a storage area of the system memory 310 having an address 0x1000 (0x indicates a hexadecimal number) to the PE 110. When the value of the register r0 is less than “0”, 1024 bytes of data are transferred from the storage area of the system memory 310 having an address 0x2000 to the PE 110. One address among three or more addresses may be selected according to the value of the register r0, and a data transfer size may be other than 1024 bytes.

The instruction transferred from the address 0x1000 or the address 0x2000 of the system memory 310 may be supplied to the instruction supply circuit 102. In a case where the received instruction is an arithmetic instruction or a wait instruction “wait”, the instruction supply circuit 102 may output the received instruction to the instruction distribution circuit 103. In a case where the received instruction is a data move instruction “mv”, the instruction supply circuit 102 may cause the DMAC to execute a data transfer. The PE 110 may then successively execute the instructions transferred from the system memory 310.

As described above, the CPU unit 120 can selectively transfer the arithmetic instruction to be executed next by the PE 110, from the system memory 310 to the PE 110, according to the branch condition obtained by the arithmetic operation of the PE 110. As a result, a branch process similar to that of the conditional branch instruction can be efficiently performed by the PE 110 which does not have an instruction fetch function and does not have a function to execute the branch instruction.

On the other hand, as illustrated on the right side of FIG. 5, in a case where the branch destination of the instruction to be executed by the PE 110 is determined by the arithmetic result of the CPU unit 120A, the CPU unit 120A may execute an addition instruction “add” for adding the values of the registers r1 and r2 of the register file RF by the CPU 122, and storing the addition result in the register r0 of the register file RF. This addition instruction “add” corresponds to an instruction for determining a branch condition to be executed before a normal conditional branch instruction.

Next, similar to the operation illustrated on the left side of FIG. 5, the CPU unit 120A may execute a data move instruction “mv” for storing the address selected according to the value of the register r0 in the instruction entry address register 125A, and a data move instruction “mv” for transferring data (instruction) of a predetermined size from the storage area of the system memory 310 indicated by the address stored in the instruction entry address register 125A to the PE 110. The PE 110 may then successively execute the instructions transferred from the system memory 310.

As described above, the CPU unit 120A can selectively transfer the arithmetic instruction to be executed next by the PE 110 from the system memory 310 to the PE 110, according to the branch condition for the PE 110 obtained by the arithmetic operation, and the PE 110 can efficiently perform the branch process similar to that of the conditional branch instruction.

As described above, in the embodiment illustrated in FIG. 4 and FIG. 5, similar to the embodiment illustrated in FIG. 1 through FIG. 3, the different types of PE 110 and CPU unit 120A installed on the processor 100A are synchronized with each other by using the tag, and thus, a plurality of processes can be executed in coordination with each other, and it is possible to improve the processing performance of the processor 100A.

Furthermore, in the embodiment illustrated in FIG. 4 and FIG. 5, a branch process similar to that of the conditional branch instruction can be efficiently performed by the PE 110 which does not have the instruction fetch function and does not have the function to execute the branch instruction.

In addition, instead of waiting for the tag to be received by the wait instruction, a polling instruction may be input to the CPU unit 120A in place of the wait instruction. In response to the polling instruction, the CPU unit 120A may periodically confirm whether or not a required arithmetic operation is completed with respect to the PE 110, for example, and a subsequent instruction may be processed when the CPU unit 120A confirms that the required arithmetic operation is completed.

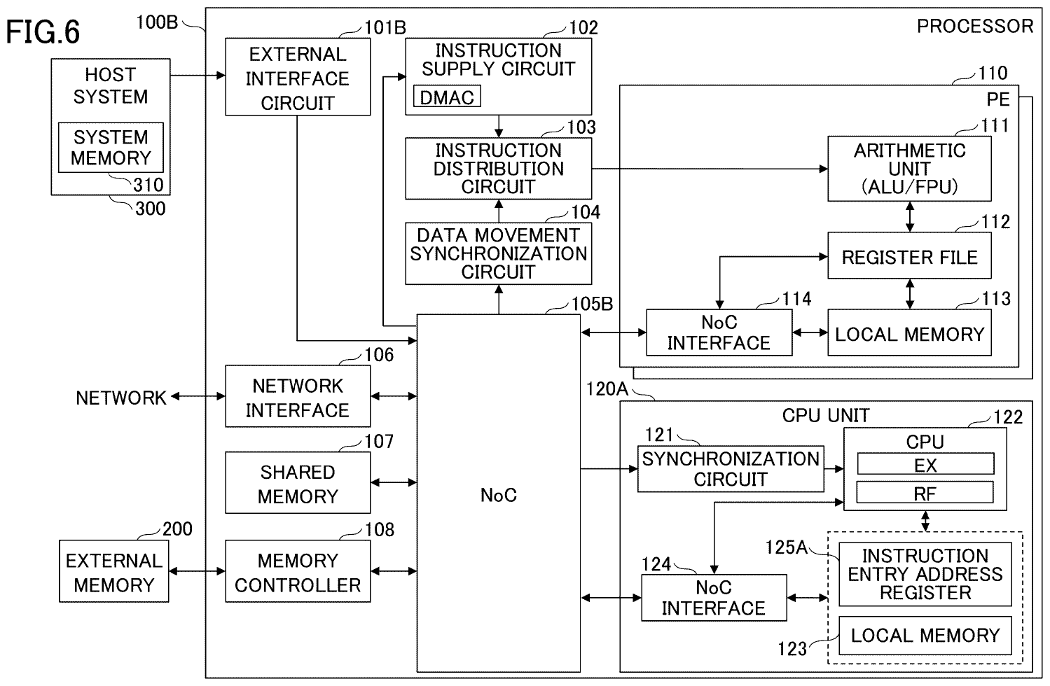

FIG. 6 is a block diagram illustrating an example of the configuration of the processor according to another embodiment of the present disclosure. In FIG. 6, those circuits that are identical or similar to those corresponding circuits illustrated in FIG. 1 and FIG. 4 are designated by the same reference numerals, and a detailed description thereof will be omitted. A processor 100B illustrated in FIG. 6 has the same configuration and functions as the processor 100 illustrated in FIG. 1, except that the processor 100B has an external interface circuit 101B, a NoC 105B, and the CPU unit 120A in place of the external interface circuit 101, the NoC 105, and the CPU unit 120 illustrated in FIG. 1. The CPU unit 120A may be the same as the CPU unit 120A illustrated in FIG. 4.

The NoC 105B has the same configuration and functions as the NoC 105 illustrated in FIG. 1, except that the NoC 105B has a function to transfer an instruction to the instruction supply circuit 102. The instruction supply circuit 102 has the same configuration and functions as the instruction supply circuit 102 illustrated in FIG. 1, except that the instruction supply circuit 102 illustrated in FIG. 6 receives the instruction from the NoC 105B.

The external interface circuit 101B may output all of the instructions read from the system memory 310 of the host system 300 to the NoC 105B. That is, the external interface circuit 101B may output an arithmetic instruction to be executed in the PE 110 and a wait instruction and a data move instruction issued from the host system 300 to the NoC 105B.

However, in this embodiment, the instruction received by the NoC 105B from the host system 300 may be prestored in the external memory 200. That is, the instruction supplied to the instruction supply circuit 102 may be transferred from the external memory 200. For this reason, the NoC 105B may include a transfer pathway for transferring the instruction received from the external memory 200 to the instruction supply circuit 102.

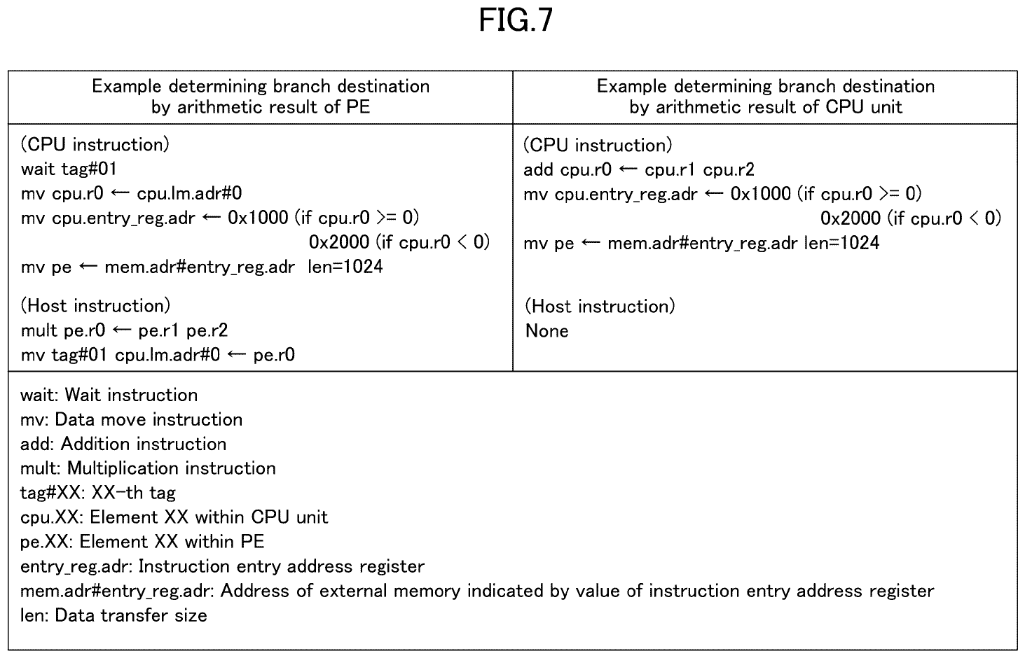

FIG. 7 is a diagram illustrating an example of the operation of the processor 100B in a case where the PE 110 illustrated in FIG. 6 is caused to selectively execute a plurality of processes. FIG. 7 illustrates an example of a method for controlling the processor 100B. A detailed description of the same or similar instructions as those illustrated in FIG. 5 will be omitted. As described above, the processor 100B may read the instructions to be executed by the PE 110 from the external memory 200.

The operation illustrated in FIG. 7 is the same as the operation illustrated in FIG. 5, except that the external memory 200 transfers the data to the PE 110 via the memory controller 108 in the last data movement instruction “mv” of the CPU instructions. For this reason, in the example illustrated in FIG. 7, the addresses 0x1000 and 0x2000 are addresses allocated to the external memory 200. The CPU unit 120A may issue a data transfer request to the DMAC by designating a transfer source address in the external memory 200.

When the value of the register r0 is “0” or greater, 1024 bytes of data may be transferred from the storage area of the external memory 200 having the address 0x1000 to the PE 110. When the value of the register r0 is less than “0”, 1024 bytes of data may be transferred from the storage area of the external memory 200 having the address 0x2000 to the PE 110. One address among three or more addresses may be selected according to the value of the register r0, and a data transfer size may be other than 1024 bytes.

For example, in a case where a data transfer request is received from the CPU unit 120A, the DMAC may issue a memory access request to the memory controller 108, and transfer the data (for example, an arithmetic instruction for the PE 110) output from the external memory 200 to the PE 110.

As described above, in the embodiment illustrated in FIG. 6 and FIG. 7, as in the embodiments illustrated in FIG. 1 through FIG. 5, the different types of PE 110 and CPU unit 120A installed on the processor 100B are synchronized with each other by using the tag, and thus, a plurality of processes can be executed in coordination with each other, and it is possible to improve the processing performance of the processor 100B. In addition, a branch process similar to that of the conditional branch instruction can be efficiently performed by the PE 110 which does not have an instruction fetch function and does not have a function to execute the branch instruction.

Further, even in the case illustrated on the right side of FIG. 7, similar to FIG. 4 and FIG. 5, while the arithmetic operation of the CPU 122 and the transfer of the arithmetic instruction by the CPU unit 120A are performed, the PE 110 may be caused to perform the arithmetic operation using another instruction sequence, and the transfer of the arithmetic instruction may be waited by using the wait instruction “wait”. Moreover, the CPU unit 120A may be configured to input a polling instruction in place of the wait instruction, instead of waiting for the tag to be received by the wait instruction. In response to the polling instruction, the CPU unit 120A may periodically confirm whether or not the required arithmetic operation is completed with respect to the PE 110, for example, and a subsequent instruction may be processed when the CPU unit 120A confirms that the required arithmetic operation is completed.

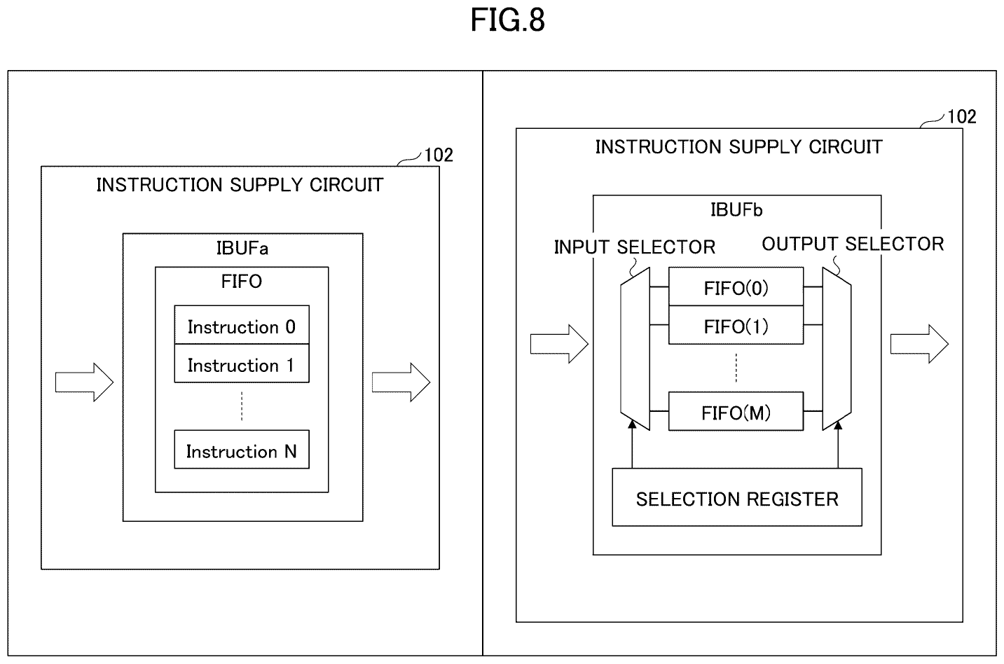

FIG. 8 is a diagram illustrating another example of the instruction supply circuit 102 illustrated in FIG. 4 or FIG. 6. For example, the instruction supply circuit 102 illustrated in FIG. 4 and FIG. 6 may include an instruction buffer IBUFa or an instruction buffer IBUFb.

The instruction buffer IBUFa may include one first-in-first-out (FIFO) configured to store N+1 instructions. The instruction buffer IBUFb may include M+1 FIFOs configured to store a smaller number of instructions than the instruction buffer IBUFa, an input selector configured to select a FIFO for storing an instruction, an output selector configured to select a FIFO from which an instruction is obtained, and a selection register configured to operate the input selector and the output selector. The input selector, the output selector, and the selection register are an example of a selection control circuit configured to select the FIFO to which the instruction is input and from which the instruction is output.

By providing either the instruction buffer IBUFa or the IBUFb having the FIFO in the instruction supply circuit 102, the instruction at the branch destination can be held in advance. For this reason, the instruction can be supplied to the PE 110 more quickly compared to a case where the instruction is transferred from the system memory 310 after the branch destination of the instruction is determined.

Furthermore, by providing the instruction buffer IBUFb having a plurality of FIFOs with a relatively small size in the instruction supply circuit 102, it is possible to hold in advance the instruction at the branch destination for a number of instructions corresponding to the number of FIFOs. Thus, even in a case where a plurality of branch destinations of the instruction are present, it is possible to reduce a probability of the instruction of the branch destination not being stored in the instruction buffer IBUFb. In the instruction buffer IBUFb, the control of storing the instruction in the FIFO and the control of obtaining the instruction from the FIFO performed by the selection register, may be performed by the CPU unit 120A.

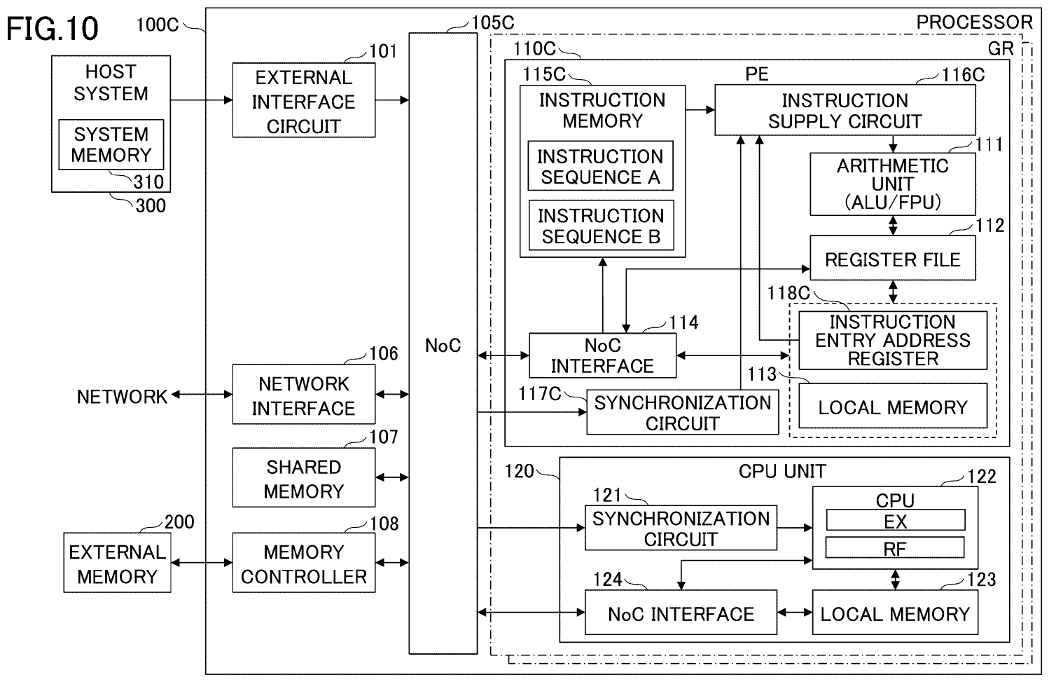

In a processor 100C illustrated in FIG. 10, because a PE 110C has an instruction memory 115C for holding an instruction sequence, the instructions can be transferred in advance from the system memory 310. For this reason, even if the processor 100C does not include the instruction buffers IBUFa and IBUFb, it is possible to prevent a delay in the supply of the instruction to the PE 110C in a case where the instruction branches. However, an instruction supply circuit 116C illustrated in FIG. 10 may be provided with a FIFO type instruction buffer.

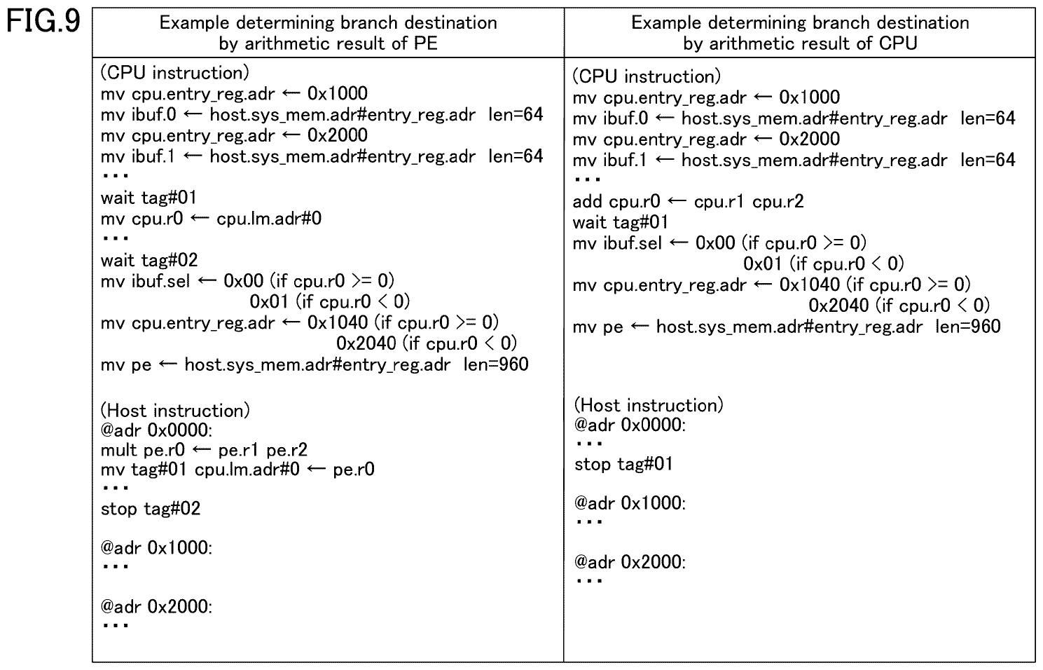

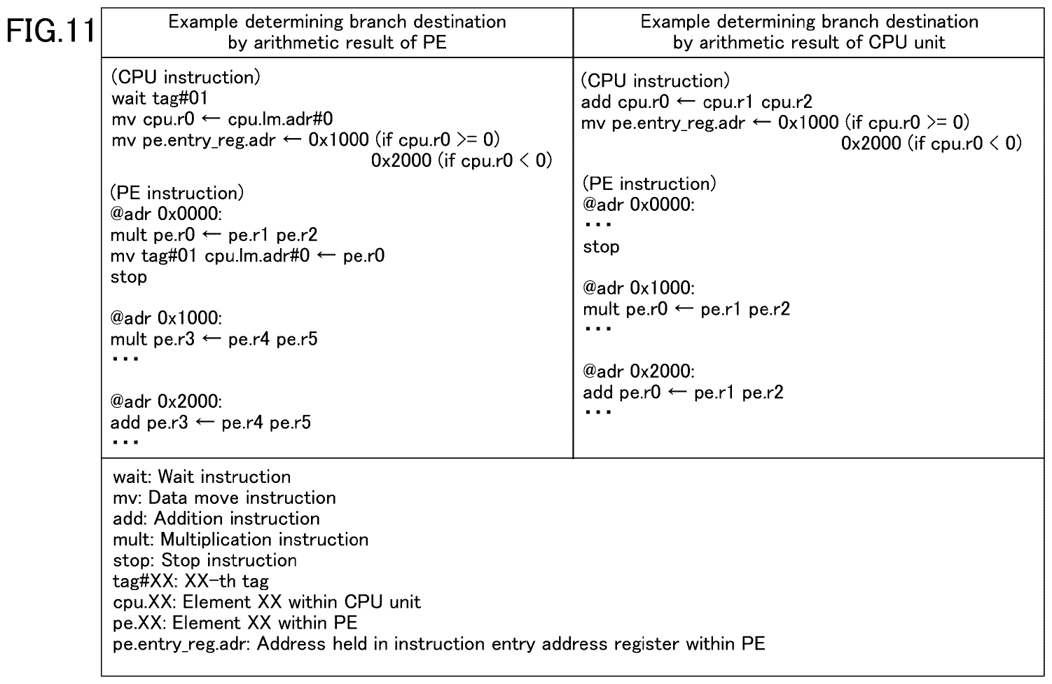

FIG. 9 is a diagram illustrating an example of the operation of the processor when the instruction supply circuit 102 illustrated in FIG. 4 includes the instruction buffer IBUFb illustrated in FIG. 8. FIG. 9 illustrates an example of a method for controlling the processor 100 illustrated in FIG. 4 and the processor 100B illustrated in FIG. 6. A detailed description of the same or similar instructions as those illustrated in FIG. 5 will be omitted. In the instructions illustrated in FIG. 9, a reference symbol ibuf.X denotes the X-th FIFO of the instruction buffer IBUFb, and a reference symbol ibuf.sel denotes a selection register for selecting a FIFO in the instruction buffer IBUFb. Further, “stop tag#X” indicates that tag#X is output to the synchronization circuit 121 of the CPU unit 120A when a stop instruction is executed. Other instructions are the same as the instructions illustrated in FIG. 3, FIG. 5, and FIG. 11.

As illustrated on the left side of FIG. 9, in a case where the branch destination of the instruction to be executed by the PE 110 is determined by the arithmetic result of the PE 110, the CPU unit 120A may execute a data move instruction “mv” for transferring 64 instructions from a head address of the address 0x1000 of the branch destination of the instruction and 64 instructions from a head address of the address 0x2000, from the system memory 310 of the host system 300 to a FIFO(0) and a FIFO(1) of the instruction buffer IBUFb, respectively, and cause the DMAC to execute the data transfer. Thereafter, the CPU unit 120A may execute a wait instruction “wait” (tag#01), and wait for the tag#01 to be received from the PE 110.

The PE 110 may start execution of the instruction from the address 0x000, execute a multiplication instruction “mult”, and acquire the multiplication result that is a branch condition for determining the branch destination of the instruction to be executed by the PE 110. The instruction supply circuit 102 may transfer the multiplication result of the PE 110 to the local memory 123 of the CPU unit 120A by using the data move instruction “mv” (tag#01), and output the tag#01 to the synchronization circuit 121 of the CPU unit 120A.

The CPU unit 120A, which receives the tag#01 in the synchronization circuit 121, may execute the data move instruction “mv”, and move the multiplication result of the PE 110 stored in the local memory 123 to the register r0. In this state, because the instruction sequence being executed in the PE 110 is not completed, the CPU unit 120A may execute a wait instruction “wait” (tag#02), and wait for the completion of the execution of the instruction sequence by the PE 110.

The PE 110 may stop the execution of the instruction by executing a stop instruction “stop” (tag#02) based on the completion of the execution of the instruction sequence, and may output the tag#02 to the synchronization circuit 121 of the CPU unit 120A.

The synchronization circuit 121 of the CPU unit 120A may cancel the wait in response to the wait instruction “wait” (tag#02), based on the reception of the tag#02. Further, the CPU unit 120A may store information for selecting a FIFO which becomes a supply source of the next instruction to the PE 110 in the selection register of the instruction buffer IBUFb, according to the multiplication result of the PE 110 held in the register r0.

In addition, the CPU unit 120A may execute a data move instruction “mv” for storing, in the instruction entry address register 125A, the head addresses of the remaining 960 instructions excluding the 64 (0x40) instructions first stored in the FIFO among the entire 1024 instructions of the instruction sequence executed by the PE 110, according to the multiplication result of the PE 110 held in the register r0. Further, the CPU unit 120A may execute a data move instruction “mv” for transferring the remaining 960 instructions, excluding the 64 instructions first stored in the FIFO among the entire 1024 instructions of the instruction sequence, from the system memory 310 of the host system 300 to the instruction supply circuit 102.

The instruction supply circuit 102 may successively supply the 960 instructions transferred from the system memory 310 to the currently selected FIFO according to the multiplication result. In this case, a data move instruction “mv pe” indicates that an instruction is supplied to the currently selected FIFO. The instruction supply circuit 102 may resume the supply of the instruction to the PE 110 that was stopped in response to the stop instruction “stop” (tag#02), as soon as it is confirmed that the instruction is stored in the currently selected FIFO.

On the other hand, as illustrated on the right side of FIG. 9, in a case where the branch destination of the instruction to be executed by the PE 110 is determined by the arithmetic result of the CPU unit 120A, the CPU unit 120A may transfer the 64 instructions from the head address of the address 0x1000 of the branch destination of the instruction and 64 instructions from the head address of the address 0x2000 to the FIFO(0) and the FIFO(1) of the instruction buffer IBUFb, respectively, similar to the case where the branch destination is determined by the arithmetic result of the PE 110.

Thereafter, the CPU unit 120A may execute an addition instruction “add”, for example, and acquire a multiplication result which is a branch condition for determining the branch destination of the instruction to be executed by the PE 110. Further, the CPU unit 120A may execute the wait instruction “wait” (tag#01), and wait for the reception of the tag#01 from the PE 110.

The PE 110 may stop the execution of the instruction by executing a stop instruction “stop” (tag#01) based on the completion of the execution of the instruction sequence, and may output the tag#01 to the synchronization circuit 121 of the CPU unit 120A.

The CPU unit 120A, which receives the tag#01 in the synchronization circuit 121, may store information for selecting a FIFO which becomes a supply source of the next instruction to the PE 110 in the selection register of the instruction buffer IBUFb, according to an addition result held in the register r0.

Moreover, the CPU unit 120A may execute a data move instruction “mv” for storing, in the instruction entry address register 125A, the head addresses of the remaining 960 instructions excluding the 64 (0x40) instructions first stored in the FIFO among the entire 1024 instructions of the instruction sequence to be executed by the PE 110, according to the addition result (branch condition) held in the register r0. Further, the CPU unit 120A may execute a data move instruction “mv” for transferring the remaining 960 instructions, excluding the 64 instructions first stored in the FIFO among the entire 1024 instructions of the instruction sequence, from the system memory 310 of the host system 300 to the instruction supply circuit 102.

The instruction supply circuit 102 may successively supply the 960 instructions transferred from the system memory 310 to the currently selected FIFO according to the multiplication result. The instruction supply circuit 102 may resume the supply of the instruction to the PE 110 that was stopped in response to the stop instruction “stop” (tag#01), as soon as it is confirmed that the instruction is stored in the currently selected FIFO.

By changing “host.sys_mem” in the instruction sequence illustrated in FIG. 9 to “mem.adr”, it is possible to obtain an instruction sequence indicating the operation for a case where the instruction buffer IBUFb illustrated in FIG. 8 is provided in the instruction supply circuit 102 of the processor 100B illustrated in FIG. 6.

In addition, the CPU unit 120A may be configured to input a polling instruction in place of the wait instruction, instead of waiting for the tag to be received by the wait instruction. In response to the polling instruction, the CPU unit 120 may periodically confirm whether or not a required arithmetic operation is completed with respect to the PE 110, for example, and may process a subsequent instruction when it is confirmed that the required arithmetic operation is completed.

FIG. 10 is a block diagram illustrating an example of the configuration of the processor according to another embodiment of the present disclosure. In FIG. 10, those circuits that are identical or similar to those corresponding circuits illustrated in FIG. 1 and FIG. 4 are designated by the same reference numerals, and a detailed description thereof will be omitted. A processor 100C illustrated in FIG. 10 may include a NoC 105C and a plurality of PEs 110C in place of the NoC 105 and the PE 110 illustrated in FIG. 1. In addition, the processor 100C may include a plurality of CPU units 120.

The processor 100C may have the functions of the instruction supply circuit 102, the instruction distribution circuit 103, and the data movement synchronization circuit 104 illustrated in FIG. 1 in each of the PEs 110C. The processor 100C may include a plurality of groups GR each including the PE 110C and the CPU unit 120. The PE 110C is an example of the first arithmetic device. The instruction supply circuit 102 is an example of an instruction supply control circuit.

A connection relationship of the external interface circuit 101, the network interface 106, the shared memory 107, and the memory controller 108, with respect to the NoC 105C may be the same as that in FIG. 1. Instructions to be executed by the PE 110C and the CPU unit 120 may be transferred from system memory 310 of host system 300 or from external memory 200.

Each PE 110C includes an arithmetic unit 111, a register file 112, a local memory 113, a NoC interface 114, an instruction memory 115C, an instruction supply circuit 116C, a synchronization circuit 117C, and an instruction entry address register 118C. The instruction entry address register 118C may include an address area for holding a head address of a storage area of the instruction memory 115C that holds an instruction sequence to be executed by the PE 110C, and a tag area for holding a tag. In addition, the instruction entry address register 118C may have a queue structure (FIFO structure) including a plurality of entries each having an address area and a tag area in which a pair of an address and a tag is held. Moreover, the instruction entry address register 118C may be allocated to a part of the local memory 113. The instruction entry address register 118C is an example of an address register configured to hold a read address indicating a read source of an instruction from the instruction memory 115C.

For example, even in a case where an address is stored in the instruction entry address register 118C, the instruction supply circuit 116C may continue to inhibit reading of the instruction from the instruction memory 115C, until the tag stored in the instruction entry address register 118C together with the address is received from the synchronization circuit 117C. In a case where a tag number (for example, tag#00) stored in the instruction entry address register 118C indicates that it is unnecessary to wait for the reception of the tag from the synchronization circuit 117C, the instruction supply circuit 116C may start reading of the instruction from the instruction memory 115C, based on the storage of the address in the instruction entry address register 118C. The tag#00 is an example of invalid synchronization information. Tags other than the tag tag#00 are examples of valid synchronization information.

The instruction memory 115C may hold in advance instruction sequences (for example, an instruction sequence A and an instruction sequence B) transferred from outside the PE 110C, via the NoC 105C and the NoC interface 114. The instruction sequence A and the instruction sequence B may include arithmetic instructions to be executed by the arithmetic unit 111.

When an address and an invalid tag are stored in the instruction entry address register 118C, the instruction supply circuit 116C may successively read instructions included in the instruction sequence from a storage area of the instruction memory 115C having the address stored in the instruction entry address register 118C as a head address. When an address and a valid tag are stored in the instruction entry address register 118C, the instruction supply circuit 116C may successively read instructions included in the instruction sequence from a storage area of the instruction memory 115C having the address stored in the instruction entry address register 118C as the head address, based on the reception of a tag which is the same as the valid tag from the synchronization circuit 117C. The instruction supply circuit 116C may supply the read instruction to the arithmetic unit 111 to cause the arithmetic unit 111 to execute an arithmetic operation.

In addition, the instruction supply circuit 116C may inhibit the supply of the arithmetic instruction subsequent to the wait instruction corresponding to the tag to the arithmetic unit 111, until the tag is received from the synchronization circuit 117C, similar to the instruction distribution circuit 103 illustrated in FIG. 1. The instruction supply circuit 116C may have a function to execute the data move instruction, and may include a DMAC that is not illustrated and has the function to execute the data move instruction. The instruction supply circuit 116C may transmit the tag to the synchronization circuit 121 of the CPU unit 120 when the execution of the data move instruction including the tag is completed.

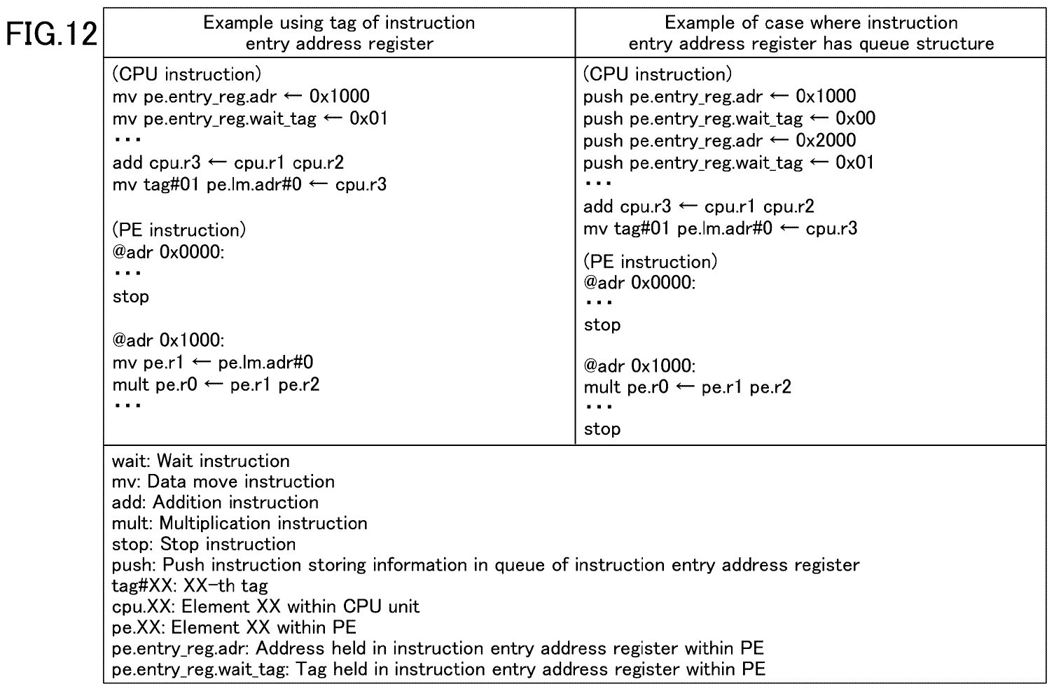

The synchronization circuit 117C may output a tag received from the CPU unit 120 via the NoC 105C to the instruction supply circuit 116C, similar to the data movement synchronization circuit 104 illustrated in FIG. 1. The synchronization circuit 117C may execute a synchronization process using the tag included in the instruction entry address register 118C. An operation using the tag included in the instruction entry address register 118C will be described in conjunction with FIG. 12.

FIG. 11 is a diagram illustrating an example of an operation of the processor 100C in a case where the PE 110C illustrated in FIG. 10 is caused to selectively execute a plurality of processes. FIG. 11 illustrates an example of a method for controlling the processor 100C. A detailed description of the instructions that are identical or similar to those corresponding instructions illustrated in FIG. 3 and FIG. 5 will be omitted. Before the operation illustrated in FIG. 11 is executed, an instruction may be stored in advance in the instruction memory 115C from the system memory 310 of the host system 300 or from the external memory 200.

FIG. 11 illustrates an example in which the tag area of the instruction entry address register 118C is not used, and the instruction supply circuit 116C reads an instruction from the instruction memory 115C based on storage of the address in the instruction entry address register 118C. In a case where the tag area is not used, invalid tag information (tag#00) may be stored in the tag area of the instruction entry address register 118C. An example which uses the tag area of the instruction entry address register 118C is illustrated in FIG. 12.

As illustrated on the left side of FIG. 11, in a case where the branch destination of the instruction to be executed by the PE 110C is determined by the arithmetic result of the PE 110C, the PE 110C starts the execution of the instruction from the address 0x000, for example. The PE 110C may successively execute the multiplication instruction “mult”, the data move instruction “mv” (tag#01), and the stop instruction “stop” that are held from the address 0x0000 of the instruction memory 115C. For example, the multiplication instruction “mult” and the data move instruction “mv” (tag#01) are the same as the multiplication instruction “mult” and the data move instruction “mv” (tag#01) illustrated in FIG. 5. The tag#01 included in the data move instruction “mv” (tag#01) used to move the data from the PE 110C to the CPU unit 120 is an example of the first synchronization information.

The instruction supply circuit 116C may have a function to execute the data move instruction “mv” read from the instruction memory 115C. The data move instruction “mv” read from the instruction memory 115C by the instruction supply circuit 116C may be executed by the DMAC provided in each group GR.

The instruction supply circuit 116C may transfer the branch condition, which is the multiplication result held in the register r0 of the register file 112, to the local memory 123 of the CPU unit 120, and transfer the tag#01 to the synchronization circuit 121 of the CPU unit 120, in response to the data move instruction “mv” (tag#01). The multiplication result and the tag#01 may be transferred to the CPU unit 120 via the NoC interface 114 and the NoC 105C. Thereafter, the instruction supply circuit 116C may stop the execution of the instruction in response to the stop instruction “stop”.

Similar to FIG. 5, the CPU unit 120 may wait for the reception of the tag#01 from PE 110C in response to the wait instruction “wait” (tag#01) including tag#01, and thereafter execute the data move instruction “mv” for reading the multiplication result (branch condition) from the local memory 123 by the PE 110C, and execute the data move instruction “mv” for storing the address corresponding to the multiplication result of the PE 110C in the instruction entry address register 118C. The address of the branch destination according to the branch condition is stored in the instruction entry address register 118C in response to the two data move instructions “mv”.

The instruction supply circuit 116C may read the address from the instruction entry address register 118C, based on the storage of the address in the instruction entry address register 118C. The instruction supply circuit 116C may successively read instructions from a storage area of the instruction memory 115C having the read address as a head address, and supply the read instructions to the arithmetic unit 111. For example, in a case where the address is 0x1000, the instruction supply circuit 116C may supply the multiplication instruction “mult” included in the instruction sequence A held in the instruction memory 115C to the arithmetic unit 111, and cause the arithmetic unit 111 to execute the multiplication instruction “mult”. In a case where the address is 0x2000, the instruction supply circuit 116C may supply the addition instruction “add” included in the instruction sequence B held in the instruction memory 115C to the arithmetic unit 111, and cause the arithmetic unit 111 to execute the addition instruction “add”.

On the other hand, as illustrated on the right side of FIG. 11, in a case where the branch destination of the instruction to be executed by the PE 110C is determined by the arithmetic result of the CPU unit 120, the CPU unit 120 may execute the addition instruction “add”, and execute the data move instruction “mv” for storing the address selected according to the branch condition for the PE 110C, which is the addition result, in the instruction entry address register 118C of the PE 110C, similar to FIG. 5.

The PE 110C may operate in a manner similar to the operation illustrated on the left side of FIG. 11. For example, the PE 110C may stop the operation in response to the stop instruction “stop”, after starting the execution of the instruction from the address 0x0000. Thereafter, the instruction supply circuit 116C may successively read the instructions held at the address 0x1000 or the address 0x2000 of the instruction memory 115C, based on the storage of the address in the instruction entry address register 118C by the CPU unit 120, and cause the arithmetic unit 111 to execute the instructions.

As described above, the instruction to be executed by the PE 110C can be selectively executed by the PE 110C, without having to transfer the instruction from outside the processor 100C to the PE 110C by the CPU unit 120. By providing the instruction memory 115C for holding the instruction within the PE 110C, a time from the storage of the address in the instruction entry address register 118C to the supply of the instruction to the instruction supply circuit 116C can be greatly reduced compared to a case where the instruction memory 115C is not provided. As a result, even in the case where the PE 110C is caused to selectively execute the instruction by utilizing the CPU unit 120, it is possible to prevent a deterioration in an instruction execution performance of the PE 110C.

The CPU unit 120 may be configured to input a polling instruction in place of the wait instruction, instead of waiting for the reception of the tag by the wait instruction. In response to the polling instruction, the CPU unit 120 may periodically confirm whether or not the required arithmetic operation is completed with respect to the PE 110C, for example, and a subsequent instruction may be processed when the CPU unit 120 confirms that the required arithmetic operation is completed.

FIG. 12 is a diagram illustrating another example of the operation of the processor 100C in the case where the PE 110C illustrated in FIG. 10 is caused to selectively execute a plurality of processes. FIG. 12 illustrates an example of a method for controlling the processor 100C. A detailed description of the instructions that are identical or similar to those corresponding instructions illustrated in FIG. 3, FIG. 5, and FIG. 11 will be omitted. In FIG. 12, before the operation illustrated in FIG. 12 is performed, an instruction may be stored in advance in the instruction memory 115C from the system memory 310 of the host system 300 or from the external memory 200.

Similar to FIG. 11, FIG. 12 illustrates an example in which the CPU unit 120 determines the instruction sequence to be executed by the PE 110C. Further, FIG. 12 illustrates an example in which the start of the arithmetic operation of the PE 110C is waited, until the data used for the arithmetic operation of the PE 110C is transferred from the CPU unit 120 to the PE 110C using the tag held in the instruction entry address register 118C.

As illustrated on the left side of FIG. 12, in a case where the tag of the instruction entry address register 118C is used, for example, the PE 110C may first start the execution of the instruction from the address 0x0000, and stop the execution of the instruction in response to a stop instruction “stop”. In this embodiment, even in a case where the address is stored in the instruction entry address register 118C, the instruction supply circuit 116C of the PE 110C continues to inhibit reading of the instruction from the address 0x1000 of the instruction memory 115C, until a valid tag is received from the synchronization circuit 117C.

After determining the instruction sequence to be executed by the PE 110C, the CPU unit 120 may execute the data move instruction “mv”, and store the address 0x1000 of the instruction memory 115C holding the determined instruction sequence in the instruction entry address register 118C. In addition, the CPU unit 120 may execute the data move instruction “mv”, and store a tag number 0x01 in the tag area of the instruction entry address register 118C.

Thereafter, the CPU unit 120 may successively execute the addition instruction “add” and the data move instruction “mv” (tag#01) for transferring the addition result to the local memory 113 of the PE 110C, and transfer the tag#01 to the synchronization circuit 117C of the PE 110C via the NoC 105C. The tag#01 included in the data move instruction “mv” (tag#01) used to move the data from the CPU unit 120 to the PE 110C is an example of the second synchronization information.

The instruction supply circuit 116C of the PE 110C may successively read instructions from the address 0x1000 of the instruction memory 115C and execute the read instructions, based on the reception of the tag#01, which is the same as the tag#01 held in the instruction entry address register 118C, via the synchronization circuit 117C. For example, the instruction supply circuit 116C may execute a multiplication instruction “mult” after executing a data move instruction “mv” for moving the data, transferred to the address adr#0 of the local memory 113 from the CPU unit 120, to the register r1 of the register file 112.

On the other hand, as illustrated on the right side of FIG. 12, in a case where the instruction entry address register 118C has a queue structure, the PE 110C may first start the execution of the instruction from the address 0x0000, for example, and stop the execution of the instruction in response to a stop instruction “stop”.

After determining the instruction sequence to be executed by the PE 110C as the first branch destination, the CPU unit 120 may successively execute push instructions “push”, and store the address 0x1000 of the instruction memory 115C holding the determined instruction sequence and the tag#00 in the instruction entry address register 118C. The push instruction “push” is an instruction to store an address and a tag in the instruction entry address register 118C having the queue structure. The tag#00 is an invalid tag indicating that the instruction supply circuit 116C will not wait for a tag from the synchronization circuit 117C.

After determining the instruction sequence to be executed by the PE 110C as the next branch destination, the CPU unit 120 may successively execute the push instructions “push”, and store the address 0x2000 of the instruction memory 115C holding the determined instruction sequence and the tag#01 in the instruction entry address register 118C. The tag#01 is a valid tag indicating that the reading of the instruction from the instruction memory 115C is inhibited until the instruction supply circuit 116C receives the tag#01 from the synchronization circuit 117C.

The PE 110C may start the execution of the instruction from the address 0x000, and stop the execution of the instruction in response to a stop instruction “stop”. Thereafter, the PE 110C immediately reads an instruction from the storage area of the instruction memory 115C having the address 0x1000 held in the instruction entry address register 118C as the head address, based on the storage of the address 0x1000 and the tag#00 indicating that the tag wait is not performed in the instruction entry address register 118C by the CPU unit 120. The PE 110C may execute the read instruction (for example, a multiplication instruction “mult”), and thereafter stop the operation in response to a stop instruction “stop”.

The CPU unit 120 may successively execute the addition instruction “add” and the data move instruction “mv” (tag#01) for transferring the addition result to the local memory 113 of the PE 110C, and transfer the tag#01 to the synchronization circuit 117C of the PE 110C via the NoC 105C.

Although not illustrated, in a case where the tag tag#01 held in the instruction entry address register 118C as a pair with the address 0x2000, and the tag#01 received via the synchronization circuit 117C match, the PE 110C may successively read instructions from a storage area of the instruction memory 115C having the address 0x2000 held in the instruction entry address register 118C as a head address, and execute the read instructions.

As described above, in FIG. 12, the execution of the instruction to be executed by the PC 110C can be made to wait, by using not only the tag included in the data move instruction “mv” but also the tag stored in the instruction entry address register 118C, and the PE 110C can be made to selectively execute the plurality of instruction sequences held in the instruction memory 115C.

As described above, similar to the embodiment illustrated in FIG. 1 through FIG. 7, the embodiment illustrated in FIG. 10 through FIG. 12 can synchronize the different types of PE 110C and CPU unit 120 installed on the processor 100C with each other by using the tag, and a plurality of processes can be executed in coordination with each other, and thus, it is possible to improve the processing performance of the processor 100C. Further, a branch process similar to that of the conditional branch instruction can be efficiently performed by the PE 110C which does not have an instruction fetch function and does not have a function to execute the branch instruction.

Further, in the embodiment illustrated in FIG. 10 through FIG. 12, even in a case where the instruction entry address register 118C is provided within the PE 110C, the PE 110C and the CPU unit 120 can execute a plurality of processes in coordination with each other, and the PE 110C can efficiently execute a branch process similar to that of the conditional branch instruction. In addition, by providing the tag area in which the valid tag or the invalid tag is stored in the instruction entry address register 118C, it is possible to execute the instruction from the branch destination without waiting for the tag, in addition to executing the instruction from the branch destination after waiting for the tag.

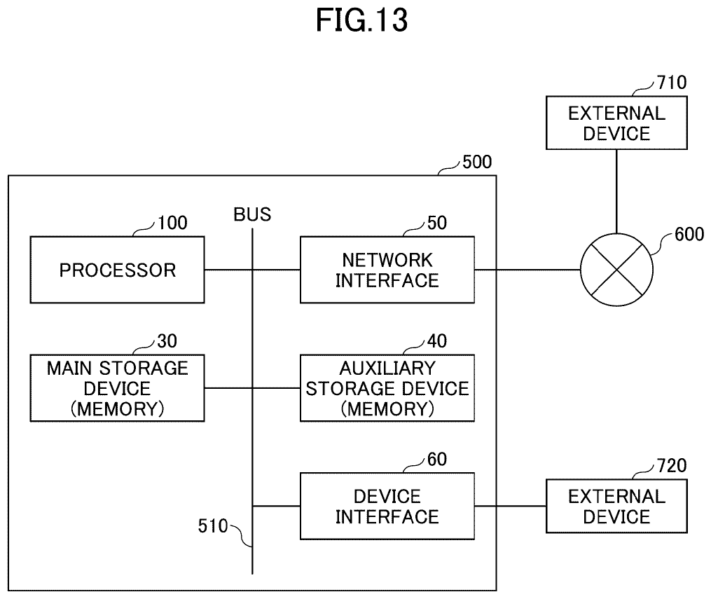

FIG. 13 is a block diagram illustrating an example of a hardware configuration of a computer installed with the processor 100 illustrated in FIG. 1. The processor 100 illustrated in FIG. 13 may be replaced with the processor 100A illustrated in FIG. 4, or the processor 100B illustrated in FIG. 6, or the processor 100C illustrated in FIG. 10. In FIG. 13, as an example, the computer may be implemented as a computer 500 including the processor 100, a main storage device (memory) 30, an auxiliary storage device (memory) 40, a network interface 50, and a device interface 60, which are connected via a bus 510. For example, the main storage device 30 may be the external memory 200 illustrated in FIG. 1.

The computer 500 illustrated in FIG. 13 includes one of each constituent element (or component), but may include a plurality of the same constituent elements. Although FIG. 13 illustrates a single computer 500, the software may be installed in a plurality of computers, and the plurality of computers may execute the processes of the same or different parts of the software. In this case, the computers may form a distributed computing system in which the computers communicate with each other via the network interface 50 or the like to execute the processes. That is, a system may be configured in which one or more computers 500 execute the instructions stored in one or more storage devices to implement the functions. In addition, information transmitted from a terminal may be processed in one or more computers 500 provided in a cloud computing system, and the processed result may be transmitted to the terminal.

The various arithmetic operations (or calculations) may be executed by parallel processing using one or a plurality of processors 100 installed in the computer 500, or using a plurality of computers 500 connected via a network. The various arithmetic operations may be distributed to a plurality of processor cores within the processor 100 and executed in parallel. Moreover, a part or all of the processes, means, or the like of the present disclosure may be implemented in at least one of a processor and a storage device provided in a cloud computing system communicable with the computer 500 via a network. As described above, each device in the embodiments described above may be in a form of a parallel computing system including one or more computers.

The processor 100 may be an electronic circuit (a processor circuit, a processing circuit, processing circuitry, a CPU, a GPU, a field programmable gate array (FPGA), an application specific integrated circuit (ASIC), or the like) that performs at least one of control and calculation of the computer. In addition, the processor 100 may be one of a general-purpose processor, a dedicated processing circuit designed to execute a specific arithmetic operation, and a semiconductor device including both the general-purpose processor and the dedicated processing circuit. Moreover, the processor 100 may include an optical circuit, or may include an arithmetic function based on quantum computing.

The processor 100 may perform an arithmetic operation based on data and software input from each device or the like of an internal configuration of the computer 500, and may output an arithmetic result or a control signal to each device or the like. The processor 100 may control each constituent element configuring the computer 500 by executing an operating system (OS), an application program, or the like of the computer 500.

The main storage device 30 may store instructions to be executed by the processor 100, various data, or the like, and information stored in the main storage device 30 may be read by the processor 100. The auxiliary storage device 40 is a storage device other than the main storage device 30. These storage devices refer to arbitrary electronic components capable of storing electronic information, and may be semiconductor memories. The semiconductor memory may either be a volatile memory or a nonvolatile memory. A storage device for storing various data or the like in the computer 500 may be implemented by the main storage device 30 or the auxiliary storage device 40, or may be implemented by a built-in memory that is built into the processor 100, or may be implemented by an embedded memory that is embedded in the processor 100.

In a case where the computer 500 is configured by at least one storage device (memory) and at least one processor 100 connected (coupled) to the at least one storage device, at least one processor 100 may be connected to one storage device. In addition, at least one storage device may be connected to one processor 100. Moreover, the configuration of the computer 500 may include at least one processor 100 among a plurality of processors 100 connected to at least one storage device among a plurality of storage devices. Further, this configuration may be implemented by the storage devices and the processors 100 included in a plurality of computers 500. In addition, the storage device may have a configuration (for example, a cache memory including a L1 cache and a L2 cache) integrated with the processor 100.

The network interface 50 is an interface for connecting the computer 500 to a communication network 600 by a wireless connection or a cable connection. The network interface 50 may be an appropriate interface, such as an interface conforming to an existing communication standard or the like. The network interface 50 may exchange information with an external device 710 connected via the communication network 600. The communication network 600 may be any one of or a combination of a wide area network (WAN), a local area network (LAN), a personal area network (PAN), or the like, and the communication network 600 may be any network capable of exchanging information between the computer 500 and the external device 710. Examples of the WAN include the Internet or the like. Examples of LAN include the IEEE 802.11, the Ethernet (registered trademark), or the like. Examples of the PAN include the Bluetooth (registered trademark), the near field communication (NFC), or the like.

The device interface 60 is an interface, such as the universal serial bus (USB) or the like, that connects directly to an external device 720.

The external device 710 is a device connected to the computer 500 via a network. The external device 720 is a device directly connected to the computer 500.

The external device 710 or the external device 720 may be an input device, for example. The input device is a device, such as a camera, a microphone, a motion capture, various sensors, a keyboard, a mouse, a touchscreen panel, or the like, for example, and provides acquired information to the computer 500. In addition, the input device may be a device including an input unit, a memory, and a processor, such as a personal computer, a tablet terminal, a smartphone, or the like.

Further, the external device 710 or the external device 720 may be an output device, for example. The output device may be a display device, such as a liquid crystal display (LCD), an organic electroluminescent (EL) panel, or the like, for example. In addition, the output device may be a speaker or the like that outputs sound or the like, for example. Moreover, the output device may be a device including an output unit, a memory, and a processor, such as a personal computer, a tablet terminal, a smartphone, or the like.

In addition, the external device 710 or the external device 720 may be a storage device (memory). For example, the external device 710 may be a network storage or the like, and the external device 720 may be a storage, such as a hard disk drive (HDD) or the like.

Moreover, the external device 710 or the external device 720 may be a device having a function of a part of the constituent elements of the computer 500. That is, the computer 500 may transmit a part or all of the processed result to the external device 710 or the external device 720, or may receive a part or all of the processed result from the external device 710 or the external device 720.

In this specification (including the claims), if the expression “at least one of a, b, and c” or “at least one of a, b, or c” is used (including similar expressions), any one of a, b, c, a-b, a-c, b-c, and a-b-c is included. Multiple instances may also be included in any of the elements, such as a-a, a-b-b, a-a-b-b-c-c, or the like. Further, the addition of another element other than the listed elements (that is, a, b, and c), such as adding d as a-b-c-d, is included.

In this specification (including the claims), if the expression such as “data as an input”, “using data”, “based on data”, “according to data”, or “in accordance with data” (including similar expressions) is used, a case where the data itself is used as an input and a case where data obtained by processing data (for example, data obtained by adding noise, normalized data, features extracted from data, intermediate representation of data, or the like) is used as an input are included, unless indicated otherwise. If it is described that any result can be obtained “data as an input”, “using data”, “based on data”, “according to data”, or “in accordance with data” (including similar expressions), a case where a result is obtained based on only the data is included, and a case where a result is obtained affected by another data other than the data, factors, conditions, and/or states may be included, unless indicated otherwise. If it is described that “data is output” (including similar expressions), a case where the data itself is used as an output is included, and a case where data obtained by processing data (for example, data obtained by adding noise, normalized data, features extracted from data, intermediate representation of data, or the like) is used as an output are included, unless indicated otherwise.

In this specification (including the claims), if the terms “connected” and “coupled” are used, the terms are intended as non-limiting terms that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the terms without being limited.

In this specification (including the claims), if the expression “A configured to B” is used, a case where a physical structure of the element A has a configuration that can perform the operation B, and a permanent or temporary setting/configuration of the element A is configured/set to actually perform the operation B may be included. For example, if the element A is a general-purpose processor, the processor may have a hardware configuration that can perform the operation B and be configured to actually perform the operation B by setting a permanent or temporary program (that is, an instruction). If the element A is a dedicated processor or a dedicated arithmetic circuit, a circuit structure of the processor may be implemented so as to actually perform the operation B irrespective of whether the control instruction and the data are actually attached.

In this specification (including the claims), if a term indicating containing or possessing (for example, “comprising/including” and “having”) is used, the term is intended as an open-ended term, including an inclusion or possession of an object other than a target object indicated by the object of the term. If the object of the term indicating an inclusion or possession is an expression that does not specify a quantity or that suggests a singular number (that is, an expression using “a” or “an” as an article), the expression should be interpreted as being not limited to a specified number.

In this specification (including the claims), even if an expression such as “one or more” or “at least one” is used in a certain description, and an expression that does not specify a quantity or that suggests a singular number is used in another description (that is, an expression using “a” or “an” as an article), it is not intended that the latter expression indicates “one”. Generally, an expression that does not specify a quantity or that suggests a singular number (that is, an expression using “a” or “an” as an article) should be interpreted as being not necessarily limited to a particular number.

In this specification, if it is described that a particular advantage/result is obtained in a particular configuration included in an embodiment, unless there is a particular reason, it should be understood that that the advantage/result may be obtained in another embodiment or other embodiments including the configuration. It should be understood, however, that the presence or absence of the advantage/result generally depends on various factors, conditions, states, and/or the like, and that the advantage/result is not necessarily obtained by the configuration. The advantage/result is merely an advantage/result that results from the configuration described in the embodiment when various factors, conditions, states, and/or the like are satisfied, and is not necessarily obtained in the claimed invention that defines the configuration or a similar configuration.

In this specification (including the claims), if multiple hardware performs predetermined processes, each of the hardware may cooperate to perform the predetermined processes, or some of the hardware may perform all of the predetermined processes. Additionally, some of the hardware may perform some of the predetermined processes while another hardware may perform the remainder of the predetermined processes. In this specification (including the claims), if an expression such as “one or more hardware perform a first process and the one or more hardware perform a second process” is used, the hardware that performs the first process may be the same as or different from the hardware that performs the second process. That is, the hardware that performs the first process and the hardware that performs the second process may be included in the one or more hardware. The hardware may include an electronic circuit, a device including an electronic circuit, or the like.

In this specification (including the claims), if multiple storage devices (memories) store data, each of the multiple storage devices (memories) may store only a portion of the data or may store an entirety of the data. Further, some of the storage devices (memories) among the multiple storage devices (memories) may be configured to store the data.

Although the embodiments of the present disclosure have been described in detail above, the present disclosure is not limited to the individual embodiments described above. Various additions, modifications, substitutions, partial deletions, and the like may be made without departing from the conceptual idea and spirit of the invention derived from the contents defined in the claims and the equivalents thereof. For example, in all of the embodiments described above, if numerical values or mathematical expressions are used for description, they are presented as an example and are not limited thereto. Additionally, the order of respective operations in the embodiment is presented as an example and is not limited thereto.

What is claimed is:

1. A processor comprising:
a first arithmetic device configured to execute a first instruction; and
a second arithmetic device configured to execute a second instruction and a third instruction, wherein:
the first arithmetic device calculates first data by executing the first instruction, and
the second arithmetic device stops execution of the third instruction based on the second instruction which is an instruction for waiting issuance of first synchronization information, and thereafter executes the third instruction that uses the first data, based on the issuance of the first synchronization information from the first arithmetic device.

2. The processor as claimed in claim 1, further comprising:
an instruction supply control circuit, wherein:
the second arithmetic device calculates second data by executing the third instruction, and
the instruction supply control circuit stops supply of a fifth instruction to the first arithmetic device based on a fourth instruction which is an instruction for waiting issuance of second synchronization information, and thereafter supplies the fifth instruction that uses the second data to the first arithmetic device based on the issuance of the second synchronization information.

3. The processor as claimed in claim 1, further comprising:
an instruction supply control circuit, wherein:
the second arithmetic device includes an address register configured to hold a read address of an instruction from a storage device,
the second arithmetic device stores an address selected according to the first data in the address register, based on the issuance of the first synchronization information,
the instruction supply control circuit reads a fourth instruction from a storage area of the storage device indicated by the address stored in the address register, and
the instruction supply control circuit supplies the fourth instruction read from the storage area to the first arithmetic device.

4. The processor as claimed in claim 1, further comprising:
an instruction supply control circuit, wherein:
the second arithmetic device includes an address register configured to hold a read address of an instruction from a storage device,
the second arithmetic device stores an address selected according to calculated third data in the address register,
the instruction supply control circuit reads a fourth instruction from a storage area of the storage device indicated by the address stored in the address register, and
the instruction supply control circuit supplies the fourth instruction read from the storage area to the first arithmetic device.

5. The processor as claimed in claim 3, wherein the instruction supply control circuit includes an instruction buffer including a FIFO configured to hold the instruction read from the storage device.

6. The processor as claimed in claim 3, wherein the instruction supply control circuit includes an instruction buffer including:
a plurality of FIFOs configured to hold instructions read from the memory device, and
a selection control circuit configured to select a FIFO to which an instruction is input and from which an instruction is output.

7. The processor as claimed in claim 1, wherein the second instruction is a wait instruction or a polling instruction.

8. The processor as claimed in claim 1, further comprising:
an instruction memory;
an instruction supply control circuit configured to supply the first instruction to the first arithmetic device; and
an address register configured to hold a read address of an instruction from the instruction memory, wherein:
the second arithmetic device stores an address selected according to the first data in the address register, based on the issuance of the first synchronization information, and
the instruction supply control circuit reads the first instruction from a storage area of the instruction memory indicated by the address stored in the address register, based on storage of the address in the address register, and supplies the first instruction to the first arithmetic device.

9. The processor as claimed in claim 8, wherein:
the address register has an area for holding synchronization information, and
the instruction supply control circuit reads an instruction from a storage area of the instruction memory indicated by the address stored in the address register, based on reception of synchronization information matching the synchronization information held in the address register, and supplies the read instruction to the first arithmetic device.

10. The processor as claimed in claim 8, wherein the address register has a FIFO structure having a plurality of areas for holding addresses and synchronization information.

11. A method for controlling a processor having a first arithmetic device configured to execute a first instruction and a second arithmetic device configured to execute a second instruction and a third instruction, the method comprising:
calculating, by the first arithmetic device, first data by executing the first instruction; and
stopping, by the second arithmetic device, execution of the third instruction based on the second instruction which is an instruction for waiting issuance of first synchronization information; and
executing, by the second arithmetic device, the third instruction that uses the first data based on the issuance of the first synchronization information from the first arithmetic device.

12. The method as claimed in claim 11, wherein the processor includes an instruction supply control circuit, the method further comprising:
calculating, by the second arithmetic device, second data by executing the third instruction;
stopping, by the instruction supply control circuit, supply of a fifth instruction to the first arithmetic device based on a fourth instruction which is an instruction for waiting issuance of second synchronization information; and
suppling, by the instruction supply control circuit, the fifth instruction that uses the second data to the first arithmetic device based on the issuance of the second synchronization information.

13. The method as claimed in claim 11, wherein the processor includes an instruction supply control circuit, and the second arithmetic device includes an address register configured to hold a read address of an instruction from a storage device, the method further comprising:
storing, by the second arithmetic device, an address selected according to the first data in the address register, based on the issuance of the first synchronization information;
reading, by the instruction supply control circuit, a fourth instruction from a storage area of the storage device indicated by the address stored in the address register; and
supplying, by the instruction supply control circuit, the fourth instruction read from the storage area to the first arithmetic device.

14. The method as claimed in claim 11, wherein the processor includes an instruction supply control circuit, and the second arithmetic device includes an address register configured to hold a read address of an instruction from a storage device, the method further comprising:
storing, by the second arithmetic device, an address selected according to calculated third data in the address register;
reading, by the instruction supply control circuit, a fourth instruction from a storage area of the storage device indicated by the address stored in the address register; and
supplying, by the instruction supply control circuit, the fourth instruction read from the storage area to the first arithmetic device.

15. The method as claimed in claim 13, wherein the instruction supply control circuit includes an instruction buffer including a FIFO configured to hold the instruction read from the storage device.

16. The method as claimed in claim 13, wherein the instruction supply control circuit includes an instruction buffer including:
a plurality of FIFOs configured to hold instructions read from the memory device, and
a selection control circuit configured to select a FIFO to which an instruction is input and from which an instruction is output.

17. The method as claimed in claim 11, wherein the second instruction is a wait instruction or a polling instruction.

18. The method as claimed in claim 11, wherein the processor includes an instruction memory, and an instruction supply control circuit and an address register, the instruction supply control circuit is configured to supply the first instruction to the first arithmetic device, and the address register is configured to hold a read address of an instruction from the instruction memory, the method further comprising:
storing, by the second arithmetic device, an address selected according to the first data in the address register, based on the issuance of the first synchronization information;
reading, by the instruction supply control circuit, the first instruction from a storage area of the instruction memory indicated by the address stored in the address register, based on storage of the address in the address register; and
supplying, by the instruction supply control circuit, the first instruction to the first arithmetic device.

19. The method as claimed in claim 18, wherein the address register has an area for holding synchronization information, the method further comprising:
reading, by the instruction supply control circuit, an instruction from a storage area of the instruction memory indicated by the address stored in the address register, based on reception of synchronization information matching the synchronization information held in the address register; and
supplying, by the instruction supply control circuit, the read instruction to the first arithmetic device.

20. The method as claimed in claim 18, wherein the address register has a FIFO structure having a plurality of areas for holding addresses and synchronization information.
